(19) United States
(12) Patent Application Publication
(10) Pub. No.: US 2025/0377093 A1
(43) Pub. Date: Dec. 11, 2025

(54) LIGHTING DEVICE

(71) Applicant: MAKITA CORPORATION, Anjo-shi (JP)

(72) Inventor: Isao YASUDA, Anjo-shi (JP)

(73) Assignee: MAKITA CORPORATION, Anjo-shi (JP)

(21) Appl. No.: 19/208,785

(22) Filed: May 15, 2025

(30) Foreign Application Priority Data
Jun. 7, 2024 (JP) 2024-093061
Apr. 11, 2025 (JP) 2025-065484

(51) Int. Cl. F21V 23/02; F21S 8/00; F21S 9/02; F21V 21/08; F21V 21/30; F21V 21/40; F21V 23/06

(52) U.S. Cl. CPC F21V 23/023; F21S 8/03; F21S 9/02; F21V 21/08; F21V 21/30; F21V 21/40; F21V 23/06

(57) ABSTRACT

A lighting device includes a first base having a fixing part, a second base extending from the first base, a battery mounting part, and a lighting part that is connected to the second base so as to be rotated around a first rotational axis crossing an extending direction of the second base. When an up-down direction is defined where a side of the first base on which the fixing part is located is defined as a lower side and a side of the first base on which the second base is located is defined as an upper side, the extending direction of the second base is a direction upward from the first base. The battery mounting part is configured such that the battery is arranged on the upper side of the first base. A connecting part between the lighting part and the second base is arranged above the battery.

### CROSS-REFERENCE TO RELATED APPLICATION

The present application claims priority to Japanese patent application Nos. 2024-093061 filed on Jun. 7, 2024 and 2025-065484 filed on Apr. 11, 2025. The contents of the foregoing applications are hereby fully incorporated herein by reference.

### TECHNICAL FIELD

The present disclosure relates to a lighting device.

### BACKGROUND

A lighting device, including a body having a grip part configured to be held by a user, a hook configured to be rotated around the grip part, and a lighting part configured to emit light, is known. For example, Japanese Unexamined Patent Application Publication No. 2012-28145 discloses a lighting device configured such that a battery can be removably mounted to a lower end of a cylindrical body of the lighting device. In this lighting device, the lighting part is rotatably mounted to an upper end of the body in order to widen a light irradiation range.

### SUMMARY

In the known lighting device, however, the battery mounted to the lower end of the body is exposed to the outside, so that the battery may not be sufficiently protected. It is therefore desirous to provide a lighting device that provides a wider light irradiation range and enhances protection of a battery.

The present disclosure can be realized as the following aspects.

According to a first aspect of the present disclosure, a lighting device is provided. The lighting device includes: a first base having a fixing part that is configured to be fixed to an installation object or an installation accessory; a second base extending from the first base; a battery mounting part that is arranged on the first or second base and has a terminal configured to be electrically connected to a battery, and a connector configured to be mechanically connected to the battery, the battery mounting part being configured such that the battery can be removably mounted thereto; and a lighting part that is configured to emit light by power supplied from the battery and is connected to the second base so as to be rotated around a first rotational axis crossing an extending direction of the second base. When an up-down direction is defined where a side of the first base on which the fixing part is located is defined as a lower side and a side of the first base on which the second base is located is defined as an upper side, the extending direction of the second base is a direction upward from the first base. The battery mounting part is configured such that the battery mounted to the battery mounting part is arranged on the upper side of the first base. A connecting part between the lighting part and the second base is arranged above the battery mounted to the battery mounting part in the up-down direction.

In the lighting device according to this aspect, the battery is arranged on the upper side of the first base together with the second base, so that the first and second bases protect the battery. Thus, protection of the battery is enhanced. Further, the connecting part between the lighting part and the second base, which defines the first rotational axis, is arranged above the battery, so that the lighting part is avoided from interfering with the battery when rotated around the first rotational axis. Thus, a rotatable range of the lighting part is widened and the light irradiation range of the lighting device is expanded.

According to a second aspect of the present disclosure, a lighting device is provided. The lighting device includes: a first base having a fixing part that is configured to be fixed to an installation object or an installation accessory; a second base extending from the first base; a battery mounting part that has a terminal configured to be electrically connected to a battery, and a connector configured to be mechanically connected to the battery, the battery mounting part being configured such that the battery can be removably mounted thereto; and a lighting part that is configured to emit light by power supplied from the battery. When an up-down direction is defined where a side of the first base on which the fixing part is located is defined as a lower side and a side of the first base on which the second base is located is defined as an upper side, an extending direction of the second base is a direction upward from the first base. The lighting part is connected to an upper end of the second base so as to be rotated around a first rotational axis crossing the extending direction of the second base. The battery mounting part is arranged in an area between the fixing part and a connecting part between the lighting part and the second base in the up-down direction.

In the lighting device according to this aspect, the battery is arranged on the upper side of the first base together with the second base, so that the first and second bases protect the battery. Thus, protection of the battery is enhanced. Further, the connecting part between the lighting part and the second base, which defines the first rotational axis, is arranged above the battery, so that the lighting part is avoided from interfering with the battery when rotated around the first rotational axis. Thus, the rotatable range of the lighting part is widened and the light irradiation range of the lighting device is expanded.

According to a third aspect of the present disclosure, a lighting device is provided. The lighting device includes: a first base; a battery mounting part that is arranged on the first base and has a terminal configured to be electrically connected to a battery, and a connector configured to be mechanically connected to the battery, the battery mounting part being configured such that the battery can be removably mounted thereto; a second base extending from an upper side of the first base in an extending direction upward from the first base, when an up-down direction is defined where a side on which the battery mounted to the battery mounting part is located relative to the first base is defined as the upper side and a side opposite to the upper side relative to the first base is defined as a lower side; and a lighting part that is configured to emit light by power supplied from the battery and is connected to the second base so as to be rotated around a first rotational axis crossing the extending direction. A connecting part between the lighting part and the second base is arranged above the battery mounted to the battery mounting part in the up-down direction.

In the lighting device according to this aspect, the battery is arranged on the upper side of the first base together with the second base, so that the first and second bases protect the battery. Thus, protection of the battery is enhanced. Further, the connecting part between the lighting part and the second base, which defines the first rotational axis, is arranged above the battery, so that the lighting part is avoided from interfering with the battery when rotated around the first rotational axis. Thus, the rotatable range of the lighting part is widened and the light irradiation range of the lighting device is expanded.

### BRIEF DESCRIPTION OF THE DRAWINGS

FIG. 1 is an explanatory view for showing the structure of a lighting device according to a first embodiment of the present disclosure, in external view.

FIG. 2 is an explanatory view for showing the structures of a first base, a second base and a lighting part.

FIG. 3 is a top view of the lighting device.

FIG. 4 is an explanatory view for showing the structure of a battery mounting part.

FIG. 5 is an explanatory view for showing the arrangement structure of a grip part.

FIG. 6 is an explanatory view for showing the structure of a connecting part in external view.

FIG. 7 is a first explanatory view for showing a rotation range of the lighting part in a side view.

FIG. 8 is a second explanatory view for showing the rotation range of the lighting part in a side view.

FIG. 9 is an explanatory view for showing the lighting device in which a light emitting surface is located in a first position.

FIG. 10 is an explanatory view for showing the lighting device in which the light emitting surface is located in a second position.

FIG. 11 is an explanatory view for showing a rotation range of the lighting part in a top view of the lighting device

FIG. 12 is an explanatory view for showing the structure of a fixing part in external view.

FIG. 13 is an explanatory view for showing the lighting device suspended by a hook.

FIG. 14 is an explanatory view for showing the arrangement position of a movable part of the lighting device according to this embodiment.

FIG. 15 is an explanatory view for showing the arrangement position of a movable part of a lighting device in a comparative example.

FIG. 16 is an explanatory view for showing a first example of an installation accessory.

FIG. 17 is an explanatory view for showing a second example of the installation accessory.

FIG. 18 is an explanatory view for showing the structure of a lighting device according to a second embodiment of the present disclosure, in external view.

FIG. 19 is an explanatory view for showing a grip part placed in a front grip position.

FIG. 20 is an explanatory view for showing the grip part placed in a rear grip position.

FIG. 21 is an explanatory view for showing the structure of a lighting device according to a third embodiment of the present disclosure, in external view.

FIG. 22 is an explanatory view for showing the positional relation between a battery mounted to a battery mounting part and a first rotational axis.

FIG. 23 is an explanatory view for showing a range in which the battery mounting part can be arranged.

FIG. 24 is an explanatory view for showing the structure of a lighting device according to a fourth embodiment of the present disclosure.

FIG. 25 is an explanatory view for showing the lighting device when a handle is operated.

FIG. 26 is an explanatory view for showing the structure of a lighting device according to a fifth embodiment of the present disclosure.

FIG. 27 is an explanatory view for showing the structure of a second base of the lighting device of the fifth embodiment.

FIG. 28 is an explanatory view for showing the arrangement structure of a grip part of a lighting device according to a sixth embodiment of the present disclosure, in a side view.

FIG. 29 is an explanatory view for showing the arrangement structure of the grip part of the lighting device of the sixth embodiment, in a top view.

FIG. 30 is an explanatory view for showing the structure of a lighting device according to a seventh embodiment of the present disclosure.

FIG. 31 is a front view of showing the structure of the lighting device according to the seventh embodiment.

FIG. 32 is an explanatory view for showing the structure of a lighting part of the seventh embodiment.

FIG. 33 is an explanatory view for showing a rotation range of the lighting part in a side view.

FIG. 34 is an explanatory view for showing a rotation range of the lighting part in a top view.

FIG. 35 is a side view for showing the structure of the lighting device according to the seventh embodiment.

FIG. 36 is a sectional view taken along line XXXVI-XXXVI in FIG. 31.

FIG. 37 is a top view for showing the structure of the lighting device according to the seventh embodiment.

FIG. 38 is an explanatory view for showing the structure of a fixing part of the seventh embodiment.

FIG. 39 is an explanatory view for showing the structure of a second surface of a cover.

FIG. 40 is an explanatory view for showing the structure of a first surface of the cover.

FIG. 41 is an explanatory view for showing the structure of a recessed part of the cover.

FIG. 42 is an explanatory view for showing the lighting device with the cover attached to a first base.

FIG. 43 is an explanatory view for showing the fixing part with the cover attached to the first base.

FIG. 44 is a first explanatory view for showing the lighting device with the cover attached to the lighting part.

FIG. 45 is a second explanatory view for showing the lighting device with the cover attached to the lighting part.

FIG. 46 is a first explanatory view for showing another example of the arrangement position of a power switch button.

FIG. 47 is a second explanatory view for showing another example of the arrangement position of a power switch button.

FIG. 48 is an explanatory view for showing another example of the method for defining an up-down direction.

### DETAILED DESCRIPTION OF THE EMBODIMENTS

Representative, non-limiting examples of the present invention are described in detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved tools and manufacturing and using methods of the tools.

Moreover, combinations of features and steps disclosed within the following detailed description may not be necessary to practice the invention in the broadest sense, and are instead taught merely to particularly describe representative examples of the invention. Furthermore, various features of the representative examples described above and below, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In at least one non-limiting embodiment according to the present disclosure, the battery mounting part may be arranged on the first base.

According to this embodiment, the battery mounted to the battery mounting part is arranged apart from the connecting part between the lighting part and the second base. Thus, the lighting part is avoided from interfering with the battery when rotated around the first rotational axis, so that the rotatable range of the lighting part is widened.

In addition or in the alternative to the preceding embodiment (In at least one non-limiting embodiment), the lighting device may further include a fixing part that is arranged on the lower side of the first base and configured to be fixed to an installation object or an installation accessory.

According to this embodiment, the lighting device is provided that can be easily fixed on the installation object and is highly convenient.

In addition or in the alternative to the preceding embodiments (In at least one non-limiting embodiment), the battery mounting part may be arranged on a side opposite to the fixing part relative to the first base.

According to this embodiment, contact between the battery and the installation object is avoided or prevented by arranging the battery on the side opposite to the fixing part.

In addition or in the alternative to the preceding embodiments, the first base may extend in a direction orthogonal to the extending direction of the second base.

According to this embodiment, the lighting device is formed in a generally rectangular (cuboid) external shape and can be reduced in size. Further, the lighting device formed in a generally rectangular (cuboid) shape is improved in designability.

In addition or in the alternative to the preceding embodiments, the fixing part may include a magnet configured to magnetically fix the first base to an installation object

According to this embodiment, the kinds of installation objects for installation of the lighting device are increased.

In addition or in the alternative to the preceding embodiments, the fixing part may include a hook configured to be hooked to an installation object.

According to this embodiment, the kinds of installation objects for installation of the lighting device are increased.

In addition or in the alternative to the preceding embodiments, the fixing part may include a female thread configured to be fitted to an installation accessory having a male thread.

According to this embodiment, the kinds of installation objects for installation of the lighting device are increased.

In addition or in the alternative to the preceding embodiments, the lighting part may be further configured to be rotated around a second rotational axis orthogonal to the first rotational axis.

According to this embodiment, by provision of the lighting part configured to be rotated around a plurality of rotational axes, the light irradiation range of the lighting device is expanded.

In addition or in the alternative to the preceding embodiments, the lighting part may have a light emitting surface that is configured to emit the light, and may be configured such that the position of the light emitting surface is changeable between a first position in which at least part of the light emitting surface is covered by the second base and a second position in which the whole of the light emitting surface is exposed to the outside of the lighting device.

According to this embodiment, the lighting device is made compact in size by changing the position of the light emitting surface to the position to be covered by the second base. Thus, the lighting device is provided that can be easily stored when not in use and is highly convenient.

In addition or in the alternative to the preceding embodiments, a front-rear direction may be defined where a direction toward the second base from a center of the first base is defined as a front direction, and the opposite direction is defined as a rear direction in a top view, and a direction orthogonal to the front-rear direction and the up-down direction may be defined as a left-right direction. A width in a longitudinal direction of the lighting part may be shorter than a width in an extending direction of the first base in a view from the left-right direction of the lighting device.

According to this embodiment, the lighting part that is a rotatable part in the lighting device is formed smaller than the first and second bases, so that the lighting device is provided that is highly convenient even for use in a narrow space.

In addition or in the alternative to the preceding embodiments, the lighting device may further have an operation member that is configured to be operated to turn on and off the lighting part. The operation member may be arranged on any of a side surface of the first base, a side surface of the second base and a side surface of the lighting part.

According to this embodiment, the operation member can be efficiently arranged by utilizing a side surface having a smaller area than the other parts.

In addition or in the alternative to the preceding embodiments, a front-rear direction may be defined where a direction toward the second base from a center of the first base is defined as a front direction, and the opposite direction is defined as a rear direction, and a direction orthogonal to the front-rear direction and the up-down direction may be defined as a left-right direction, in a top view of the first base. The operation member may be arranged on a right or left side surface of the second base.

According to this embodiment, the lighting device is provided that facilitates two operations of adjusting the direction of light irradiation by the lighting part and turning on and off the lighting device, and is highly convenient.

In addition or in the alternative to the preceding embodiments, the lighting device may further have a grip part configured to be held by a user. A front-rear direction is defined where a direction toward the second base from a center of the first base is defined as a front direction, and the opposite direction is defined as a rear direction, and a direction orthogonal to the front-rear direction and the up-down direction is defined as a left-right direction, in a top view of the first base. The grip part may be arranged between a lower end of the first base and a connecting part between the lighting part and the second base in the up-down direction, in a rear area behind the second base, in a view from the left-right direction of the lighting device.

According to this embodiment, the number of parts to be arranged in a front part of the lighting device is reduced. Thus, the lighting device is provided that has the front part simplified in structure and has high designability.

In addition or in the alternative to the preceding embodiments, the grip part may be arranged above the first base in the rear area.

According to this embodiment, the grip part is arranged in the vicinity of the battery, so that the lighting device can be reduced in size.

In addition or in the alternative to the preceding embodiments, the first base, the second base and the lighting part all may have a cuboid shape.

According to this embodiment, by using a cuboid member for each part of the lighting device, the lighting device is provided with high designability.

In addition or in the alternative to the preceding embodiments, the lighting device may further have an operation member that is configured to be manually operated in one direction by a user to turn on and off the lighting part. An axis that is parallel to a depressing direction of the operation member and passes through the operation member may be arranged to pass through the first base.

According to this embodiment, by provision of the operation member configured to be depressed in the direction toward the first base, the lighting device can be held stably on the installation object while the operation member is operated.

In addition or in the alternative to the preceding embodiments, the lighting device may further have a handle including: (i) a pair of base parts that extend rearward from the second base, and (ii) a grip part that is connected between the base parts and configured to be held by a user, when a front-rear direction is defined where a direction toward the second base from a center of the first base is defined as a front direction and the opposite direction is defined as a rear direction in a top view of the first base. The operation member may be arranged in an area surrounded by the second base, the base parts and the grip part.

According to this embodiment, a user can easily operate the operation member while holding the grip part.

In addition or in the alternative to the preceding embodiments, the lighting device may further have a handle including: (i) a pair of base parts that extend rearward from the second base, and (ii) a grip part that is connected between the base parts and configured to be held by a user, when a front-rear direction is defined where a direction toward the second base from a center of the first base is defined as a front direction and the opposite direction is defined as a rear direction in a top view of the first base. The grip part may be arranged below an uppermost end of an area that the lighting part occupies when rotated around the first rotational axis.

According to this embodiment, the arrangement of the grip part below the uppermost end of the rotatable range of the lighting part avoids or prevents increase in size of the lighting device in the up-down direction.

In addition or in the alternative to the preceding embodiments, the grip part may be arranged below the uppermost end and just above the first base.

According to this embodiment, the upper surface of the first base, or the battery mounted on the upper surface of the first base can be protected by utilizing the handle.

In addition or in the alternative to the preceding embodiments, the lighting device may have a cover that is configured to cover at least part of the lighting device when removably attached to at least one position of the lighting device. The at least part of the lighting device may include a lower side of the fixing part.

According to this embodiment, the function of the fixing part for fixing the lighting device to an installation object or an installation accessory is stopped or suppressed by a simple method of attaching the cover in a manner to cover the lower side of the fixing part.

In addition or in the alternative to the preceding embodiments, the cover may have a first surface that faces the lighting device with the cover attached to the least one position of the lighting device, and a second surface on the opposite side to the first surface. The second surface may have a support projection that protrudes in a direction away from the lighting device with the cover attached to the least one position of the lighting device.

According to this embodiment, the distance between the fixing part and the installation object is increased, so that the effect of stopping or suppressing the function of the fixing part for fixing the lighting device to an installation object or an installation accessory via the cover is more effectively exhibited.

In addition or in the alternative to the preceding embodiments, the cover may be configured to be attached to two or more positions including: (i) the lower side of the first base and (ii) a position other than the lower side of the first base, on the first base, the second base or the lighting part.

According to this embodiment, when the cover is not attached to the lower side of the first base, the cover can be mounted to a position other than the lower side of the first base so that loss of the cover is avoided or prevented.

### A. FIRST EMBODIMENT

### A1. The Structure of Parts of a Lighting Device 100

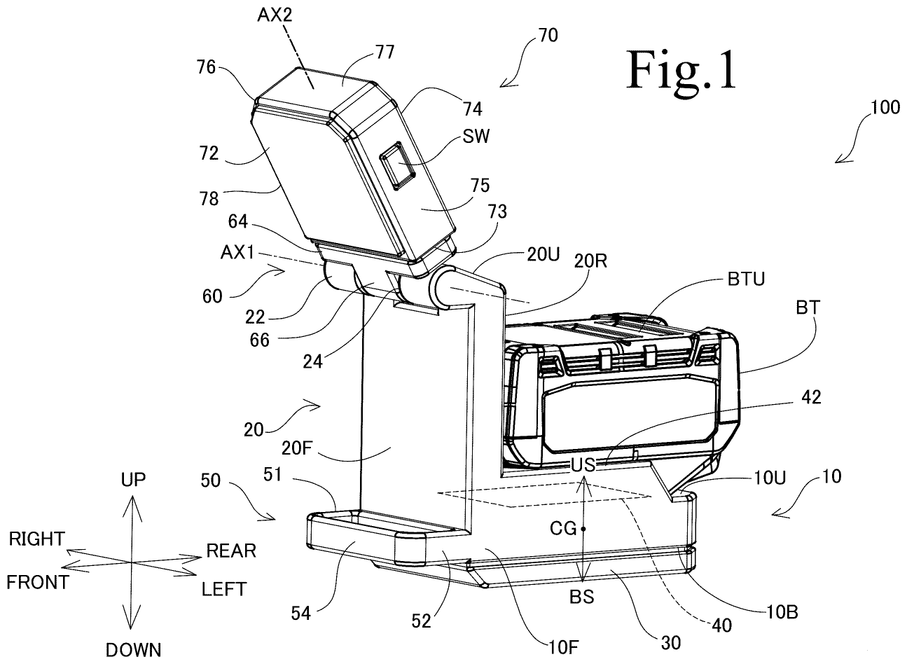

FIG. 1 shows a lighting device 100 according to a first embodiment. The lighting device 100 is configured to be operated by power supplied from a rechargeable battery BT and used to illuminate, for example, a hand of a user. The lighting device 100 is a portable lighting device suitable for carrying, installing on an installation object and changing the installation position. The lighting device 100 has a first base 10, a second base 20, a battery mounting part 40 and a lighting part 70.

The first base 10 and the second base 20 can serve as a body and a housing of the lighting device 100. The first base 10 and the second base 20 can house, for example, an electric wire for electrically connecting the battery BT and the lighting part 70, a terminal, a connector and a switching element(s). The first and second bases 10, 20 may further house a controller for controlling drive and illuminance of the lighting part 70.

In this embodiment, the first and second bases 10, 20 are integrally formed, for example, using synthetic resin such as an ABS resin. The first and second bases 10, 20 connected together form the body of the lighting device 100 having a bent external shape. The bent body covers the battery BT from two directions, so that the possibility of contact between the battery BT and an installation object is reduced. The first and second bases 10, 20 may be formed of metal instead of synthetic resin, or of synthetic resin and metal. Further, the first and second bases 10, 20 may be formed not integrally but separately.

The first base 10 has a generally cuboid shape having an upper surface 10U and a lower surface 10B. When the lighting device 100 is placed on an installation object, the first base 10 is exclusively placed on the installation object in a manner to face the installation object. The first base 10 includes a fixing part 30. The fixing part 30 is configured to fix the lighting device 100 to the installation object or an installation accessory (described below). Where the first base 10 includes the fixing part 30, the fixing part 30 is exclusively placed to face the installation object. The shape of the first base 10 is not limited to a cuboid, but it may be any shape such as a cube, a sphere, a disc and a flat plate-like shape.

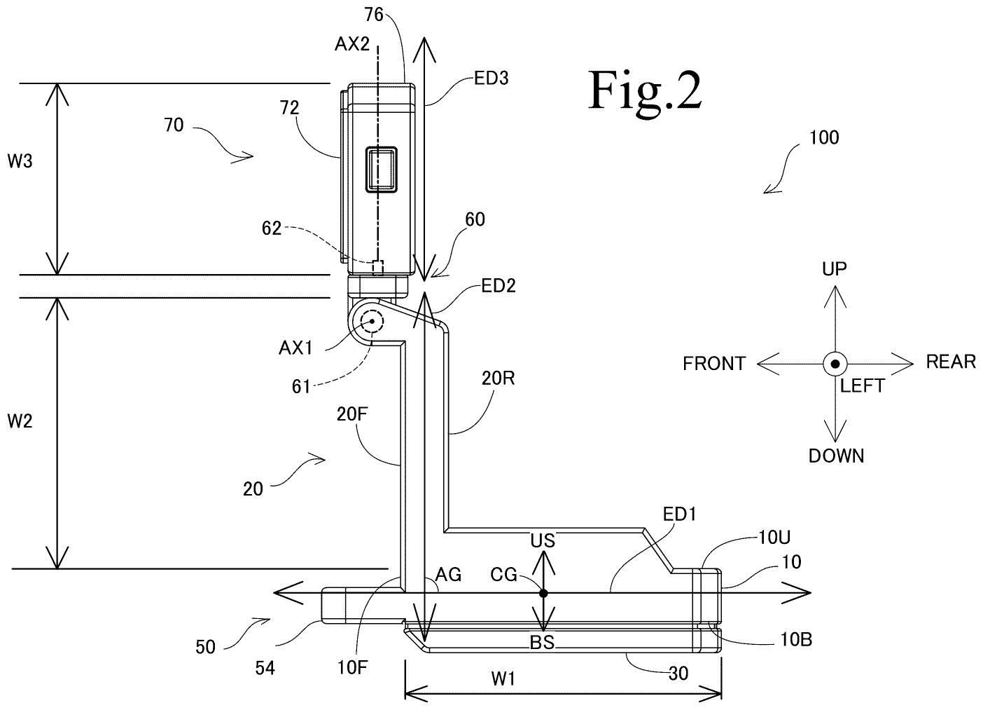

In the following description, an “up-down direction” is defined where the side on which the fixing part 30 is located relative to any reference position in the first base 10 is defined as a lower side BS, and the side on which the second base 20 is located relative to the reference position is defined as an upper side US. For example, the direction of a normal line to the lower surface 10B or the upper surface 10U of the first base 10 may be defined as the up-down direction. In the up-down direction, the side on which the fixing part 30 is located relative to any reference position in the first base 10 may be defined as the lower side BS, and the side on which the second base 20 is located relative to the reference position may be defined as the upper side US. The reference position in the first base 10 may be set, for example, at a center of gravity CG of the first base 10. In this case, for example, as shown in FIG. 2, a direction toward the fixing part 30 from the center of gravity CG of the first base 10 at the shortest distance may be defined as a “lower direction”, and the opposite direction may be defined as an “upper direction”. The reference position in the first base 10 may be set at the center of the first base 10.

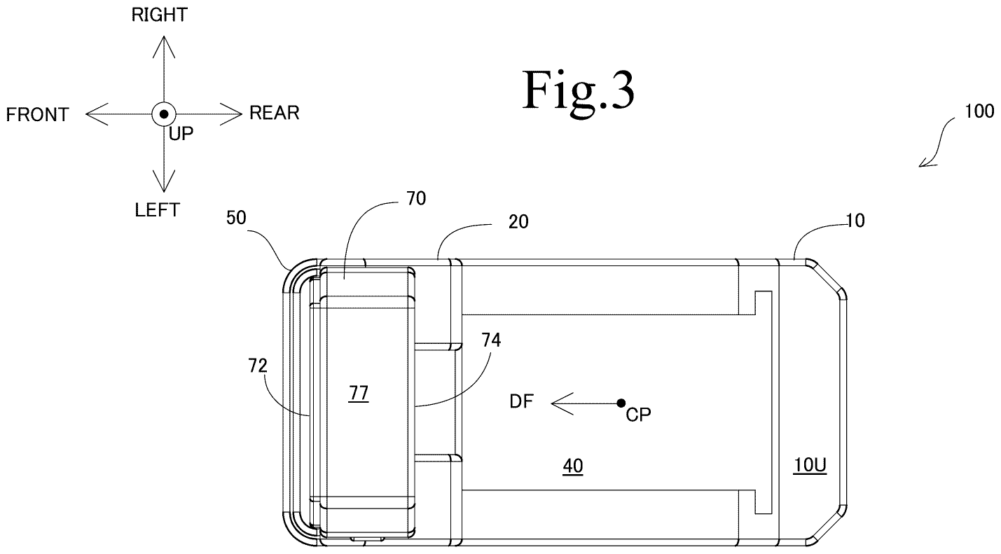

As shown in FIG. 1, the second base 20 is connected to the upper surface 10U of the first base 10. As shown in FIG. 3, a “front-rear direction” is defined where a direction DF toward the second base 20 from a center CP of the outer contour of the first base 10 in a top view of the first base 10 is defined as a front direction, and the opposite direction is defined as a rear direction. A direction orthogonal to the front-rear direction and the up-down direction is defined as a “left-right direction”. In FIG. 3, for ease of technical understanding, the battery BT and parts of the battery mounting part 40 are not shown.

As shown in FIG. 2, in this embodiment, the first base 10 has a generally cuboid external shape long in the front-rear direction. In this embodiment, where a longitudinal direction in which the first base 10 extends is defined as a “first extending direction ED1”, the first extending direction ED1 is parallel to the front-rear direction. In FIG. 2, for ease of technical understanding, the battery BT is not shown.

As shown in FIG. 2, the second base 20 has a generally cuboid shape, having a front surface 20F, and a rear surface 20R on the side opposite to the front surface 20F. The second base 20 extends upward from the upper surface 10U of the first base 10 at a front end 10F of the first base 10. The second base 20 is formed in such a position and a shape as to be easily held by a user when the first base 10 is placed on the installation object. The second base 20 has a generally cuboid external shape long in the up-down direction. Where a longitudinal direction of the second base 20 is defined as a “second extending direction ED2”, the second extending direction ED2 is parallel to the up-down direction. In this embodiment, an upper end part of the second base 20 has a pair of bent parts 22 bent frontward. The shape of the second base 20 is not limited to a cuboid, but it may be any shape such as a cube, a sphere, a disc and a flat plate-like shape.

In this embodiment, an angle AG between the first extending direction ED1 and the second extending direction ED2 is approximately 90° in a view from the left-right direction of the lighting device 100. In other words, in this embodiment, the first base 10 and the second base 20 are connected together into a generally L-shape in a view from the left-right direction of the lighting device 100. The second base 20 may extend upward not from the front end 10F of the first base 10, but from a position closer to the center of the first base 10 than the front end 10F. In other words, the first base 10 and the second base 20 may be connected together into a generally T-shape in a view from the left-right direction of the lighting device 100. Further, the angle AG is not limited to 90°, but it may be set to any angle. The angle AG is preferably set to 80° to 100° from the viewpoint of enhancing protection of the battery BT.

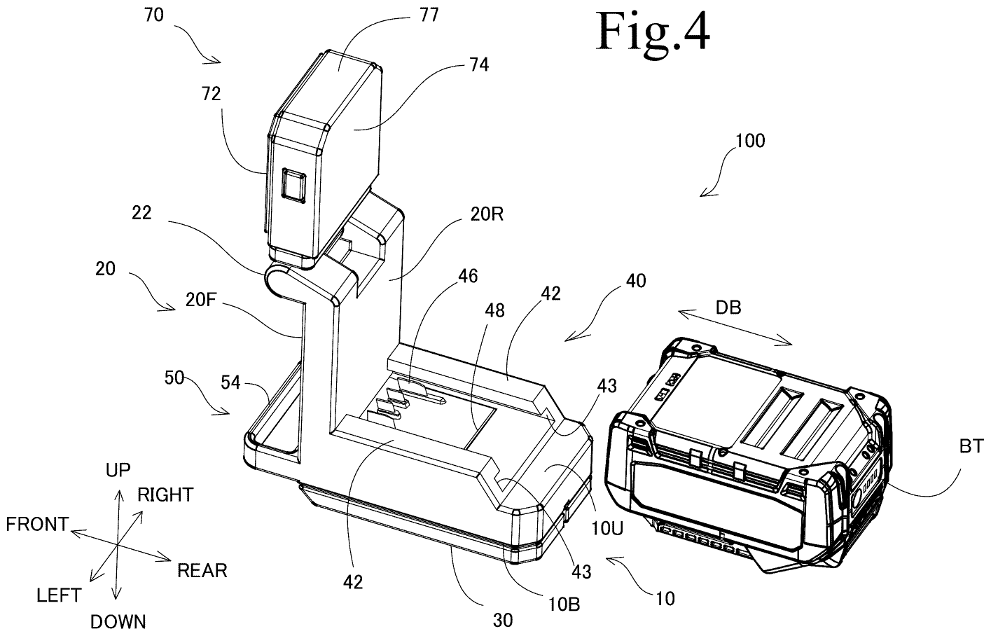

As shown in FIG. 4, the battery mounting part 40 is configured such that the battery BT can be removably mounted thereto. The battery BT is a known battery pack or secondary battery, such as a lithium-ion battery including cells. The battery BT is, for example, a 36 V battery having a battery capacity of 4.0 to 5.0 Ah. The battery mounting part 40 has side walls 42, terminals 46 and a connector 48.

The side walls 42 are formed on the upper surface 10U of the first base 10. Specifically, the side walls 42 respectively extend upward from right and left ends of the upper surface 10U. A recessed guide groove 43 is formed in each of the side walls 42. The guide grooves 43 are configured to be engaged with rails of the battery BT and define a mounting/removing direction DB of the battery BT to mount and remove the battery BT.

The terminals 46 are connected to a power terminal (not shown) formed on the battery BT. The terminals 46 are arranged on the upper surface 10U. The terminals 46 are electrically connected to a circuit board disposed in the lighting part 70, via wirings arranged in the first and second bases 10, 20. The battery BT is electrically connected to the lighting part 70 by connection between the terminals 46 and the power terminal of the battery BT.

The connector 48 is configured to be mechanically connected to the battery BT. The battery BT is fixed to the battery mounting part 40 by engagement between the connector 48 and a projection of the battery BT.

In an example shown in FIG. 4, the mounting/removing direction DB of the battery BT is parallel to the front-rear direction. A user can remove the battery BT from the battery mounting part 40 by pulling out the battery BT rearward along the mounting/removing direction DB from the battery mounting part 40. Further, a user can mount the battery BT to the battery mounting part 40 by pushing in the battery BT frontward along the mounting/removing direction DB. Power can be supplied to the lighting part 70 and the controller by the battery BT mounted to the battery mounting part 40.

In this embodiment, the battery mounting part 40 is arranged on the opposite side of the first base 10 to the fixing part 30. Specifically, the battery mounting part 40 is arranged on the upper surface 10U of the first base 10. Thus, the battery mounting part 40 is configured such that the battery BT mounted to the battery mounting part 40 is arranged on the upper side of the first base 10. With this configuration, the first and second bases 10, 20 protect the battery BT mounted to the battery mounting part 40, so that contact between the battery BT and the installation object OB is avoided or prevented. Further, even when the lighting device 100 drops, the battery BT is more likely to be protected by the first and second bases 10, 20, and avoided or prevented from directly hitting the ground.

The lighting part 70 emits light from a light emitting surface 72 by power supply from the battery BT. As shown in FIG. 1, the lighting part 70 includes a housing 76, a circuit board disposed within the housing 76 and a light emitting element mounted on the circuit board, and the light emitting surface 72 for emitting light from the light emitting element. The lighting part 70 is connected to an upper end part of the second base 20.

The light emitting element is, for example, an LED (light emitting diode) that is operated by power supply from the battery BT. The number of the light emitting elements may be freely set, for example, according to the illuminance required of the lighting device 100. A reflector may be provided around the light emitting element to adjust the optical path of light. A heatsink may be provided on the circuit board to cool the circuit board.

As shown in FIG. 2, the housing 76 has a generally cuboid external shape long in the front-rear direction. The housing 76 extends in a direction away from a connecting member 60 (described below) or the second base 20. Where the extending direction of the housing 76 is defined as a “third extending direction ED3”, the third extending direction ED3 is a longitudinal direction of the housing 76 in a view from the left-right direction of the lighting device 100. The third extending direction ED3 crosses a first rotational axis AX1 (described below). In this embodiment, the third extending direction ED3 is orthogonal to the first rotational axis AX1 and parallel to a second rotational axis AX2 (described below). The shape of the housing 76 is not limited to a cuboid, but it may be any shape such as a cube, a sphere and a disc-like shape. The housing 76 may have a generally cuboid shape long along the first rotational axis AX1.

As shown in FIG. 1, the housing 76 has a generally cuboid shape, having the light emitting surface 72, and a rear surface 74 on the side opposite to the light emitting surface 72. Where surfaces connecting the light emitting surface 72 and the rear surface 74 are defined as “side surfaces of the housing 76”, one of the side surfaces that faces the connecting member 60 described below is defined as a “lower side surface 73”, and the opposite surface to the lower side surface 73 is defined as an “upper side surface 77”. Where the light emitting surface 72 faces frontward, the left side surface of the housing 76 is defined as a “left side surface 75”, and the right side surface is defined as a “right side surface 78”. The upper side surface 77, the lower side surface 73, the left side surface 75 and the right side surface 78 are examples of the “side surfaces” of the lighting part 70.

The light emitting surface 72 is formed of transparent synthetic resin or glass. The light emitting surface 72 transmits light emitted from the light emitting element disposed within the housing 76 and emits the light to the outside of the housing 76. The light emitting surface 72 serves as a so-called diffuser to defuse light emitted from the light emitting element. The diffuser reduces variation in luminance of the emitted light and substantially uniformizes an illuminance distribution.

As shown in FIG. 1, a power switch button SW is arranged on the left side surface 75 of the housing 76. The light emitting element is turned on or off according to user's manual operation of the power switch button SW. Specifically, when the power switch button SW is operated, a switching element (not shown) mounted on the circuit board within the housing 76 is operated to turn on and off the light emitting element. The power switch button SW is an example of the “operation member”.

In FIG. 2, a width W1 of the first base 10, a width W2 of the second base 20 and a width W3 of the housing 76 of the lighting part 70 are shown in a view from the left-right direction of the lighting device 100. The width W1 is the length of the first base 10 in the first extending direction ED1, the width W2 is the length of the second base 20 in the second extending direction ED2, and the width W3 is the length of the housing 76 in the third extending direction ED3.

In this embodiment, the width W1 and the width W2 are set substantially equal to each other. Thus, the lighting device 100 including the battery BT has a generally cubic external shape, so that the designability of the lighting device 100 is improved.

The width W1 and the width W2 are set to be, for example, 100 mm or less. In this embodiment, the widths W1, W2 are approximately 80 mm. A width of a general lighting device is set to be, for example, approximately 150 to 200 mm. The lighting device 100 of this embodiment is formed smaller than the general lighting device, and thus improved in portability and enhanced in convenience.

As shown in FIG. 1, in this embodiment, the widths of the first and second bases 10, 20 in the left-right direction are substantially equal to the width in the left-right direction of the battery BT mounted to the battery mounting part 40. Further, the length of the first base 10 in the front-rear direction is set to be shorter than the length of the battery BT in the front-rear direction. Thus, the size of the lighting device 100 of this embodiment is reduced to about the same size as the battery BT.

As shown in FIG. 2, the housing 76 of the lighting part 70 is configured to have the width W3 shorter than the width W1 of the first base 10. The “width W3 of the housing 76” means the width of the housing 76 along the third extending direction ED3, or the width of the lighting part 70 along the second rotational axis AX2. The lighting part 70 that is a rotatable part in the lighting device 100 is formed smaller than the body of the lighting device 100, so that the lighting device 100 is provided that is highly convenient even for use in a small space.

The housing 76 is configured to have the width W3 shorter than the width W2 of the second base 20. With the configuration of the lighting part 70 smaller than the second base 20, as described below, the lighting device 100 with the lighting part 70 in contact with the front surface 20F is made compact in size. Thus, the lighting device 100 is provided with high convenience for use. Further, the lighting part 70 is avoided from getting into contact with the other members when the lighting part 70 is rotated around the first rotational axis AX1.

As shown in FIG. 1, in this embodiment, the lighting device 100 further has a handle 50. The handle 50 has base parts 51, 52 and a grip part 54. The grip part 54 is configured to be held by a user. In this embodiment, the grip part 54 is covered with a material such as elastomer that is suitable for preventing slippage of the hand gripping the grip part 54.

As shown in FIG. 1, the base parts 51, 52 extend frontward from the front end 10F of the first base 10 and connects the grip part 54 and the front end 10F of the first base 10. The base parts 51, 52, the grip part 54 and the front end 10F of the first base 10 form the annular handle 50. The handle 50 need not be annular. For example, either one of the base parts 51, 52 may be omitted. In this embodiment, the handle 50 is integrally formed with the first base 10. The handle 50 may be connected to the second base 20 or the fixing part 30 described below. In this case, the handle 50 may be integrally formed with the second base 20 or the fixing part 30.

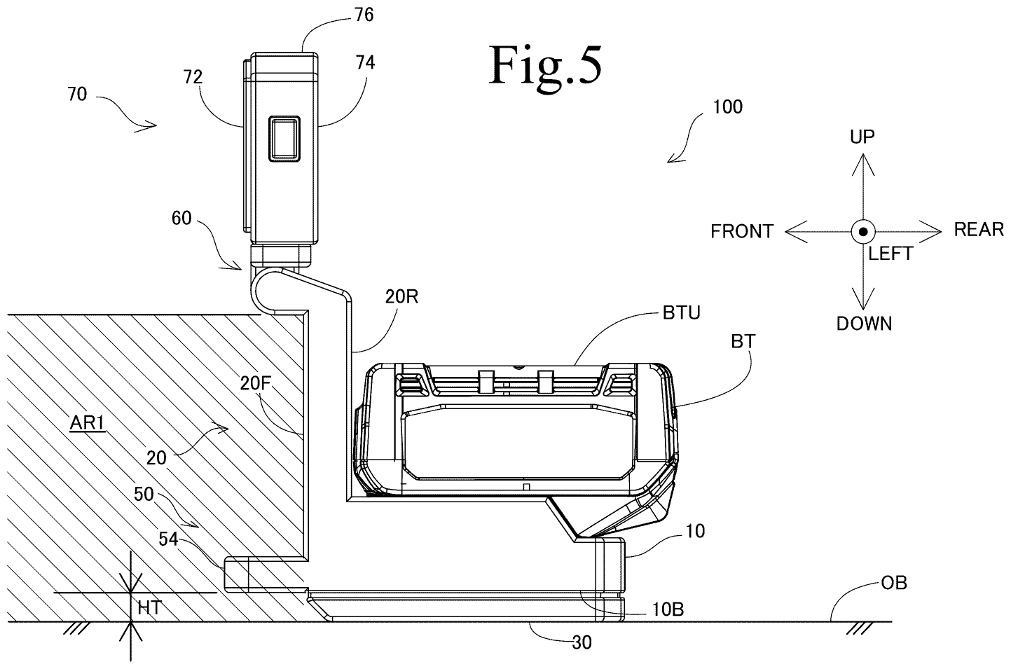

As shown in FIG. 5, the grip part 54 is arranged in an area AR1 in front of the lighting device 100. The “area AR1” is an area in front of the second base 20 in a view from the left-right direction of the lighting device 100, and between a lower end of the first base 10 and the connecting member 60 in the up-down direction. The “lower end of the first base 10” means a lower surface of the fixing part 30 if the fixing part 30 is provided on the first base 10, and if not, it means a lower end (such as the lower surface 10B) of the first base 10 excluding the fixing part 30. By the arrangement of the grip part 54 on the front side of the lighting device 100, the lighting device 100 is provided that is easy to hold and highly convenient. Further, by the arrangement of the grip part 54 on the opposite side of the second base 20 to the battery BT, a user can easily hold the balance of the lighting device 100 while holding the grip part 54, and can suitably carry the lighting device 100 with the battery BT mounted thereon.

In this embodiment, the grip part 54 is further arranged at a predetermined height HT from the lower surface of the fixing part 30 in the area AR1. The height HT is preferably, for example, 20 mm or more. This arrangement allows a user to easily insert fingers between the installation object OB and the grip part 54 and easily hold the grip part 54 even when the lighting device 100 is placed on the installation object OB. Thus, the lighting device 100 is provided that is convenient for carrying via the handle 50.

### A2. The Structure of the Connecting Member 60

In this embodiment, the lighting part 70 is connected to the second base 20 via the connecting member 60. The connecting member 60 connects the lighting part 70 and the second base 20 such that the lighting part 70 can be rotated around the first rotational axis AX1 relative to the second base 20. The connecting member 60 is an example of the “connecting part” that connects the lighting part 70 and the second base 20. In this embodiment, the connecting member 60 is connected to the lighting part 70 such that the lighting part 70 can also be rotated around the second rotational axis AX2 relative to the connecting member 60.

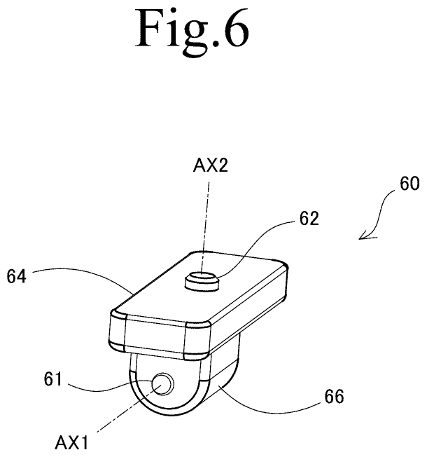

As shown in FIG. 6, the connecting member 60 has a generally flat plate-like base part 64 and a protruding part 66 protruding from the base part 64. The protruding part 66 has a shape conforming to a recess 24 defined between the bent parts 22 of the second base 20. A pair of generally cylindrical first fitting parts 61 are formed on both side surfaces of the protruding part 66 and protrude along the first rotational axis AX1. The first fitting parts 61 are inserted into fitting holes (not shown) formed in the recess 24 of the second base 20. In this state, the lighting part 70 can be rotated around the first rotational axis AX1 relative to the second base 20.

The first rotational axis AX1 is, for example, parallel to the second base 20. By rotation of the lighting part 70 around the first rotational axis AX1, the light emitting surface 72 of the lighting part 70 is turned between a position facing the front surface 20F of the second base 20 and a position not facing the front surface 20F of the second base 20.

In this embodiment, the first rotational axis AX1 is orthogonal to the second extending direction ED2 of the second base 20 and substantially parallel to the front surface 20F of the second base 20. A user can adjust the direction of the light emitting surface 72 around the first rotational axis AX1 by rotating the lighting part 70, and thus can freely adjust the irradiation direction of light of the lighting device 100 around the first rotational axis AX1. In this embodiment, the “direction of the light emitting surface 72” means a normal direction to the light emitting surface 72.

An upper surface of the base part 64 faces the lower side surface 73 of the lighting part 70. The upper surface of the base part 64 has a shape corresponding to the shape of the lower side surface 73 of the lighting part 70. A generally cylindrical second fitting part 62 is formed on the upper surface of the base part 64 and protrudes along the second rotational axis AX2. The second fitting part 62 is inserted into a fitting hole (not shown) formed in the lower side surface 73 of the lighting part 70. In this state, the lighting part 70 can be rotated around the second rotational axis AX2 relative to the connecting member 60. The first and second fitting parts 61, 62 may be fitting holes respectively having shapes conforming to protrusions formed in the lighting part 70 and the second base 20.

The second rotational axis AX2 crosses the first rotational axis AX1 and is substantially parallel to the light emitting surface 72. In this embodiment, the second rotational axis AX2 is orthogonal to the first rotational axis AX1. A user can rotate the lighting part 70 to adjust the direction of the light emitting surface 72 around the second rotational axis AX2, or, for example, to switch the direction of the light emitting surface 72 in the left-right direction. Thus, the light irradiation range of the lighting device 100 is expanded.

### A3. The Rotatable Range of the Lighting Part 70

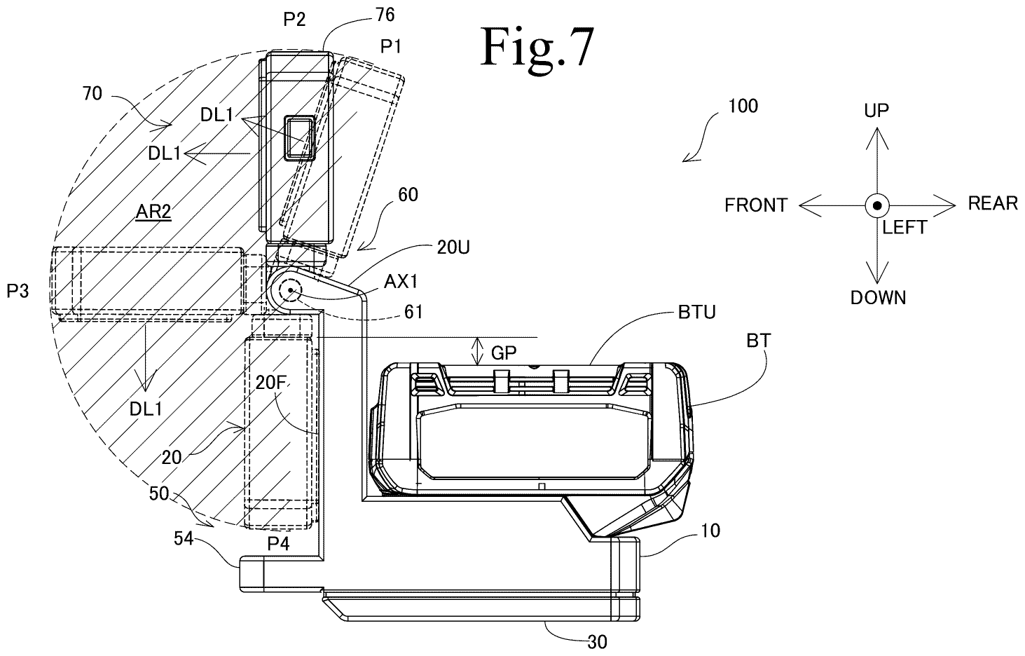

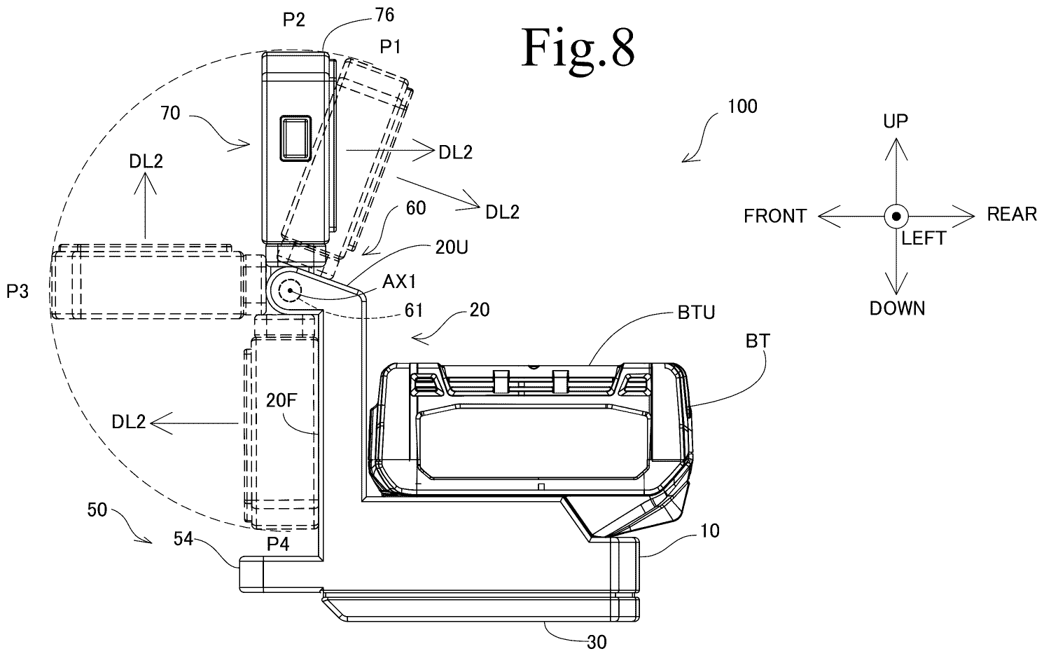

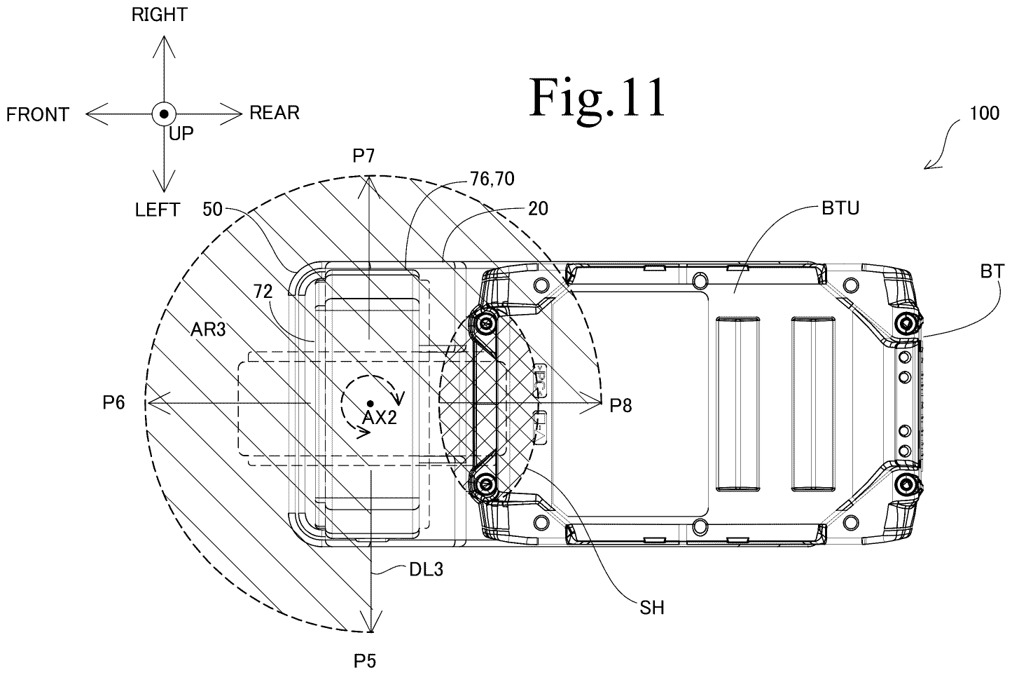

A rotatable range of the lighting part 70 is now described with reference to FIGS. 7 to 11. The rotatable range of the lighting part 70 is also an adjustable range in which the direction of the light emitting surface 72 can be adjusted. In FIGS. 7 and 8, a rotatable range of the lighting part 70 around the first rotational axis AX1 is shown, and in FIG. 11, a rotatable range of the lighting part 70 around the second rotational axis AX2 is shown. In FIG. 7, the lighting part 70 placed in a position P2 (described below) is shown where a direction DL1 of the light emitting surface 72 is the front direction, in a view from the left-right direction of the lighting device 100. In FIG. 8, the lighting part 70 placed in the position P2 is shown where a direction DL2 of the light emitting surface 72 is the rear direction.

In FIG. 7, a rotatable range AR2 of the lighting part 70 around the first rotational axis AX1 is schematically shown in a view from the left-right direction of the lighting device 100. In this embodiment, an angle over which the lighting part 70 can be rotated in the rotatable range AR2 is approximately 200°. Thus, the direction DL1 of the light emitting surface 72 can be freely adjusted in the range of the rotation angle of approximately 200° in directions including the front and lower directions.

When the lighting part 70 is rotated 180° around the second rotational axis AX2 from the state shown in FIG. 7, the light emitting surface 72 is directed in the direction DL2 shown in FIG. 8. As shown in FIG. 8, the direction DL2 of the light emitting surface 72 can be freely adjusted in the range of the rotation angle of approximately 200° in directions including the front, rear and upper directions.

As shown in FIGS. 7 and 8, the position of the lighting part 70 can be changed to any position in the range from a position P1 to a position P4 by rotation of the lighting part 70 around the first rotational axis AX1. Exemplary positions P2 and P3 included in the range from the position P1 to the position P4 are also shown in FIGS. 7 and 8.

The “position P2” is a position of the lighting part 70 in which the second rotational axis AX2 is parallel to the up-down direction. When the lighting part 70 is rotated clockwise from the position P2, the lighting part 70 is moved rearward to the position P1.

The “position P1” is a position in which the lighting part 70 is restricted from rotating clockwise. The clockwise rotation of the lighting part 70 is restricted by abutment of the lower surface of the base part 64 of the connecting member 60 on the upper surface 20U of the second base 20. In this embodiment, in the position P1, the lighting part 70 is inclined approximately 20° rearward from the position P2. The inclination angle is, however, not limited to 20°, but it may be set to any angle such as 15°, 30°, 45° and 90° to the position P2. Further, the lighting part 70 may be rotated to a position to come into contact with the battery BT mounted to the battery mounting part 40 or to a position immediately before the contact.

The “position P3” is a position of the lighting part 70 inclined 90° frontward from the position P2. In the position P3, the third extending direction ED3 and the second rotational axis AX2 coincide with the front-rear direction. When the lighting part 70 is further rotated 90° counterclockwise from the position P3, the lighting part 70 is placed in the position P4.

The “position P4” is a position in which the lighting part 70 is restricted from rotating counterclockwise. The lighting part 70 is placed in the position P4 when rotated 180° counterclockwise from the position P2. In the position P4, the third extending direction ED3 and the second rotational axis AX2 coincide with the up-down direction. The counterclockwise rotation of the lighting part 70 is restricted by abutment of the lighting part 70 or the connecting member 60 on the front surface 20F of the second base 20.

As shown in FIG. 7, in this embodiment, the lighting device 100 is configured such that the rotatable range AR2 does not overlap with the position of the grip part 54. Specifically, the grip part 54 and the lighting part 70 are arranged in a positional relation to prevent interference with each other. Thus, the rotation range of the lighting part 70 is avoided from being reduced due to the existence of the grip part 54, while the grip part 54 is arranged on the front side of the lighting device 100.

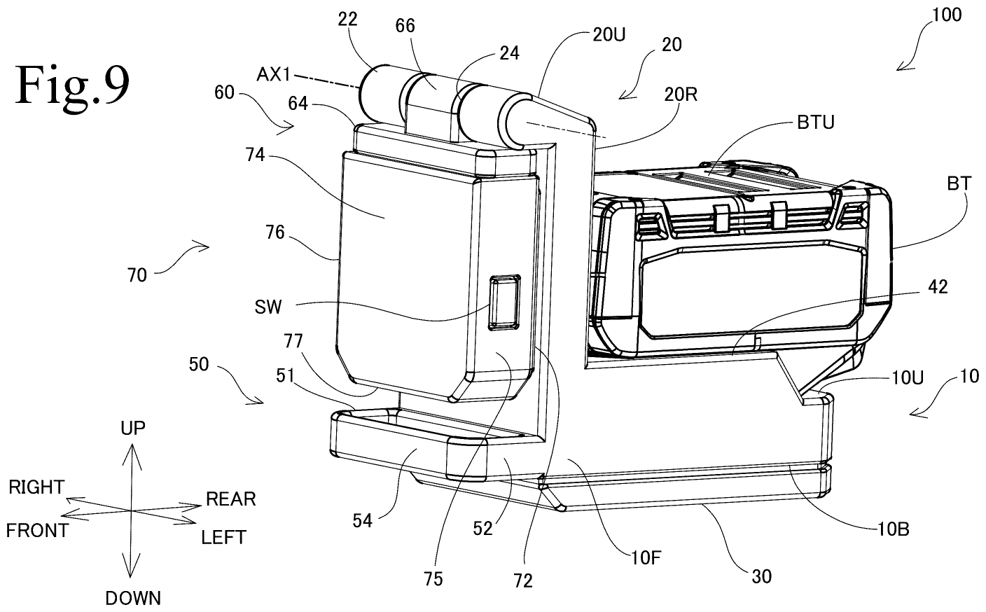

FIG. 9 shows the lighting device 100 with the lighting part 70 placed in the position P4 shown in FIG. 7. As shown in FIG. 9, the light emitting surface 72 faces the front surface 20F of the second base 20 and is covered by the front surface 20F. The position of the light emitting surface 72 in which the light emitting surface 72 is covered by the front surface 20F is also referred to as a “first position”. In the first position, the whole or at least part of the light emitting surface 72 may be covered by the front surface 20F.

When the light emitting surface 72 is placed in the first position, the light emitting surface 72 is avoided from being exposed to the outside, so that protection of the light emitting surface 72 is enhanced. When the light emitting surface 72 is placed in the first position and the whole of the light emitting surface 72 is covered by the front surface 20F, the lighting device 100 is turned into a so-called OFF state in which the lighting device 100 does not emit light regardless of user's operation of the power switch button SW. Further, the lighting device 100 can be turned into a more compact size by covering the light emitting surface 72 with the front surface 20F. The first position is a suitable position for the lighting device 100 when not in use. Thus, the lighting device 100 is provided that can be turned into a suitable state for storage when not in use, and is highly convenient.

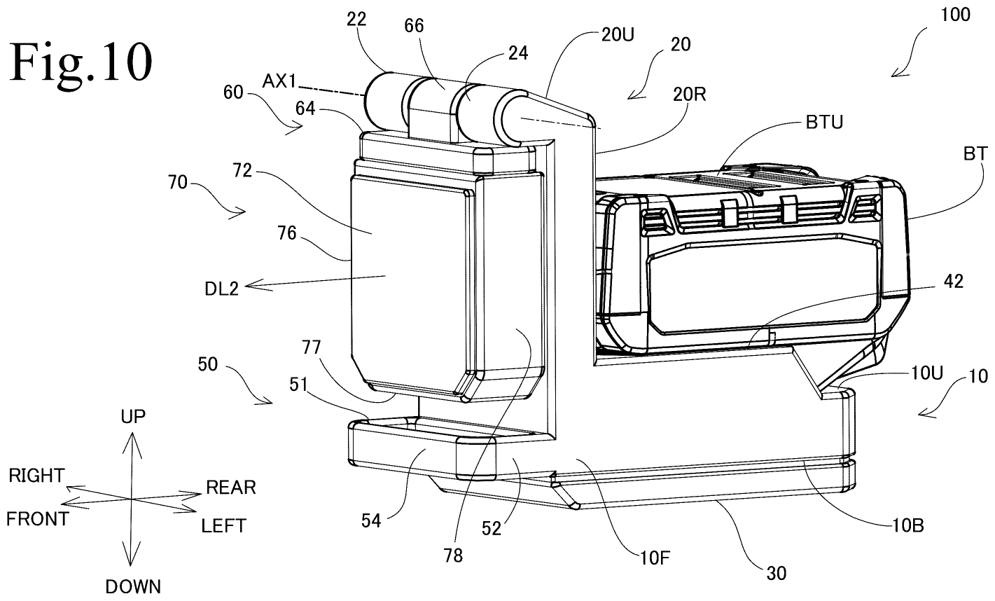

FIG. 10 shows the lighting device 100 with the lighting part 70 placed in the position P4 shown in FIG. 8. As shown in FIG. 10, the whole of the light emitting surface 72 does not face the front surface 20F of the second base 20 and is directed outward of the lighting device 100. The position of the light emitting surface 72 in which the whole of the light emitting surface 72 is not covered by the front surface 20F is also referred to as a “second position”. The positions in which the lighting part 70 shown in FIG. 7 is placed in the positions P1, P2 and P3 and the positions in which the lighting part 70 shown in FIG. 8 is placed in the positions P1, P2, P3 and P4 correspond to the “second position”. When the light emitting surface 72 is placed in the second position, the lighting device 100 is placed in a so-called ON state in which the lighting device 100 can emit light to the outside. In the second position, the lighting device 100 can emit light in a compact state when the light emitting surface 72, the second base 20 and the battery BT mounted to the battery mounting part 40 are arranged linearly along the front-rear direction.

As shown in FIG. 7, in this embodiment, the lighting device 100 is configured such that the connecting member 60 is arranged above the battery BT mounted to the battery mounting part 40 in the up-down direction. Specifically, when the lighting part 70 is placed in the position P4, a gap GP exists in the up-down direction between an upper end BTU of the battery BT and the connecting member 60 in the position P4 in which the connecting member 60 is placed in the lowest position. Thus, in this embodiment, the lighting device 100 is configured such that the connecting member 60 is arranged above the upper end BTU of the battery BT in any position of the connecting member 60. The “upper end BTU of the battery BT” means an upper end of the battery BT mounted to the battery mounting part 40.

In the lighting device 100 of this embodiment, by the arrangement of the connection part between the lighting part 70 and the second base 20 above the upper end BTU of the battery BT, the rotatable range of the lighting part 70 is avoided from being reduced due to contact between the lighting part 70 and the battery BT. By this arrangement, for example, when the lighting part 70 is rotated around the first rotational axis AX1, an area in which the rotatable range of the lighting part 70 overlaps with the area of the battery BT is reduced. Thus, the rotatable range of the lighting part 70 around the first rotational axis AX1 is widened.

In FIG. 11, a rotatable range AR3 of the lighting part 70 around the second rotational axis AX2 is shown in a top view of the lighting device 100. In this embodiment, an angle over which the lighting part 70 can be rotated in the rotatable range AR3 is approximately 270°. Thus, a direction DL3 of the light emitting surface 72 can be freely adjusted in the range of the rotation angle of approximately 270° in directions including the front-rear direction and the left-right direction. The rotatable range AR3 is, however, not limited to 270°, but it may be set to any angle such as 180° and 360°.

As shown in FIG. 11, the position of the lighting part 70 can be changed to any position in the range from a position P5 to a position P8 in a top view of the lighting device 100 by rotating the lighting part 70 around the second rotational axis AX2. Exemplary positions P6 and P7 included in the range from the position P5 to the position P8 are also shown in FIG. 11.

The “position P5” is a position of the lighting part 70 in which the direction DL3 of the light emitting surface 72 is the left direction. The “position P6” is a position of the lighting part 70 in which the direction DL3 of the light emitting surface 72 is the front direction. The “position P7” is a position of the lighting part 70 in which the direction DL3 of the light emitting surface 72 is the right direction. The “position P8” is a position of the lighting part 70 in which the direction DL3 of the light emitting surface 72 is the rear direction. The lighting part 70 is restricted from rotating counterclockwise from the position P5 to the position P8 and from rotating clockwise from the position P8 to the position P5 by restricting members (not shown) provided on the connecting member 60 and the lighting part 70.

In this embodiment, as described above, the lighting device 100 is configured such that the connecting member 60 is arranged above the upper end BTU of the battery BT. This avoids or prevents the lighting part 70 from getting into contact with the battery BT when the lighting part 70 is rotated around the second rotational axis AX2 as shown in FIG. 11. For example, the lighting part 70 does not get into contact with the battery BT in an area SH shown in FIG. 11 even when the lighting part 70 is rotated around the second rotational axis AX2. Therefore, in the lighting device 100 according to this embodiment, by the arrangement of the connecting member 60 above the upper end BTU of the battery BT, the direction DL3 of the light emitting surface 72 can be changed to the front, rear, right and left directions and thus emit light over a wider range. The above description is made in an example shown in FIG. 11, for convenience of explanation, in which the lighting part 70 placed in the position P2 shown in FIG. 7 is rotated around the second rotational axis AX2, but the same is true when the lighting part 70 placed in the position P1, P3 is rotated around the second rotational axis AX2.

### A4. The Structure of the Fixing Part 30

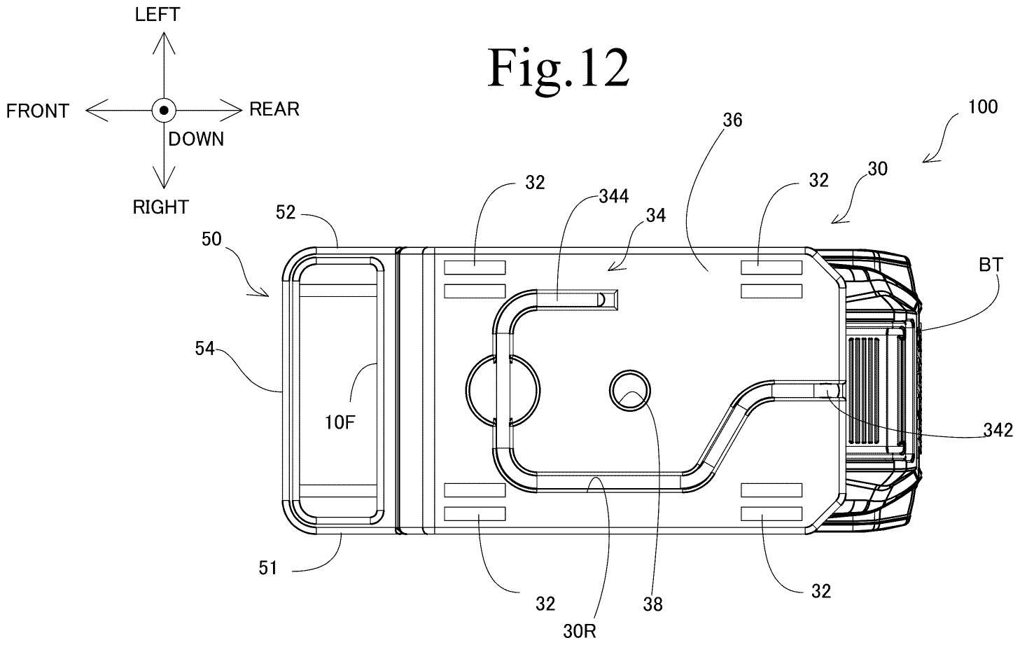

The structure of the fixing part 30 is now described with reference to FIGS. 12 to 17. As shown in FIG. 12, the fixing part 30 includes magnets 32, a hook 34, a base body 36 and a female thread 38.

The base body 36 has the same external shape as the first base 10 in plan view, having a generally cuboid shape long in the first extending direction ED1. The base body 36 is formed of synthetic resin or metal. A lower surface of the base body 36 is covered by a member having a high friction coefficient such as rubber in order to avoid slippage of the lighting device 100 on an installation object.

Each of the magnets 32 is a permanent magnet such as a neodymium magnet. In this embodiment, the magnets 32 are arranged at the four corners of the base body 36. The magnets 32 may be arranged to be exposed to the surface of the base body 36, or arranged inside the base body 36. The number and size of the magnets 32 may be freely set, for example, according to the size of the fixing part 30 or the weight of the lighting device 100. The magnets 32 are used to magnetically fix the first base 10, for example, to a ferromagnetic installation object. Therefore, the kinds of installation objects for installation of the lighting device 100 are increased. The magnet 32 may be an electromagnet in place of the permanent magnet.

The hook 34 can be used to hung and fix the lighting device 100, for example, by hooking to the installation object. The hook 34 is formed of synthetic resin or metal. The hook 34 has a spherical movable part 342 and a body part 344 having a tip end part bent into a generally U-shape.

The movable part 342 is connected to the other end part of the body part 344. The movable part 342 connects the body part 344 and the base body 36 such that the body part 344 can rotate relative to the base body 36. The body part 344 can be stored in a recessed part 30R of the base body 36.

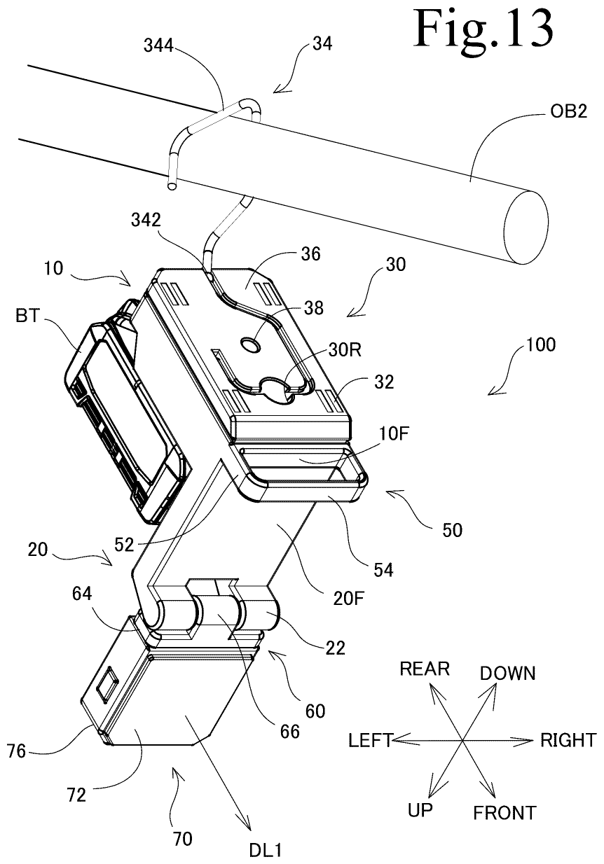

As shown in FIG. 13, in using the hook 34, the body part 344 is taken out of the recessed part 30R. The taken-out body part 344 can be hooked to an installation object OB2 such as a rope and a pipe to hung and fix the lighting device 100 to the installation object OB2. By such a simple method, the lighting device 100 can be installed at a high position and illuminate an area below the lighting device 100.

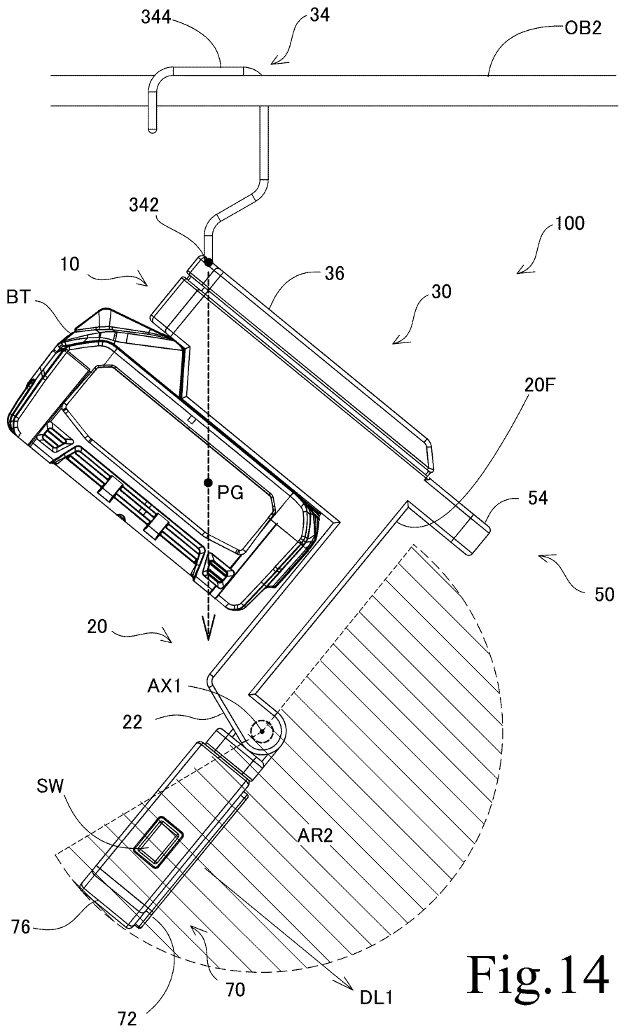

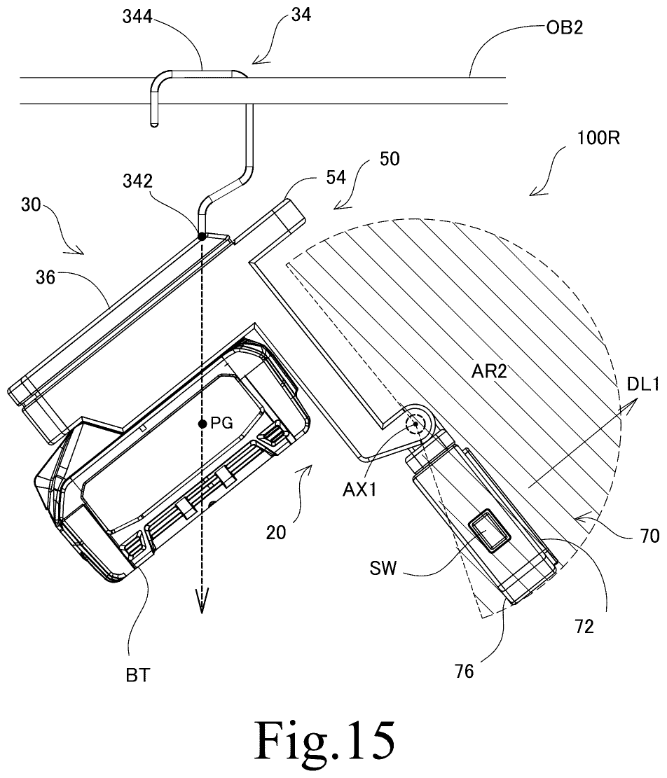

The arrangement structure of the movable part 342 relative to the base body 36 is now described with reference to FIGS. 14 and 15. In FIG. 15, a lighting device 100R of a comparative example is shown. In FIGS. 14 and 15, a center of gravity PG of the lighting device 100, 100R with the battery BT mounted to the battery mounting part 40 is schematically shown. The lighting device 100, 100R hooked to the installation object OB2 by the hook 34 is fixed where the movable part 342 and the center of gravity PG are aligned in the vertical direction. Therefore, the fixing position of the hanged lighting device 100, 100R can be adjusted by adjusting the position of the movable part 342 relative to the center of gravity PG. Thus, the irradiation range of light below the lighting device 100 can be freely adjusted.

As shown in FIG. 15, in the lighting device 100R of the comparative example, the movable part 342 is arranged on a front end part of the base body 36, or close to the second base 20. Thus, in the lighting device 100R, the light emitting surface 72 is directed upward in the vertical direction in most of the range of adjustment of the direction DL1 of the light emitting surface 72 when the lighting part 70 is rotated around the first rotational axis AX1. Further, in this case, the grip part 54 of the handle 50 is also located above the movable part 342 in the vertical direction. Therefore, a user cannot easily hold the grip part 54 from below the lighting device 100R in the vertical direction.

In the lighting device 100 of this embodiment, however, as shown in FIG. 14, the movable part 342 is arranged on a rear end part of the base body 36, or apart from the second base 20. Thus, in the lighting device 100, compared with the lighting device 100R of the comparative example, the light emitting surface 72 is directed downward in the vertical direction in most of the range of adjustment of the direction DL1 of the light emitting surface 72 when the lighting part 70 is rotated around the first rotational axis AX1. Therefore, according to this embodiment, the lighting device 100 can irradiate light to a wider area below the lighting device 100 in the vertical direction even when hooked to the installation object OB2 by the hook 34. Further, in this case, the grip part 54 is located below the movable part 342 in the vertical direction. Therefore, a user can easily hold the grip part 54 even from below the lighting device 100 in the vertical direction. Furthermore, the lighting part 70 is located at a lower position, so that a user can easily adjust the direction of the lighting part 70 even from below the lighting device 100 in the vertical direction and can easily operate the power switch button SW arranged on the left side surface 75 of the lighting part 70.

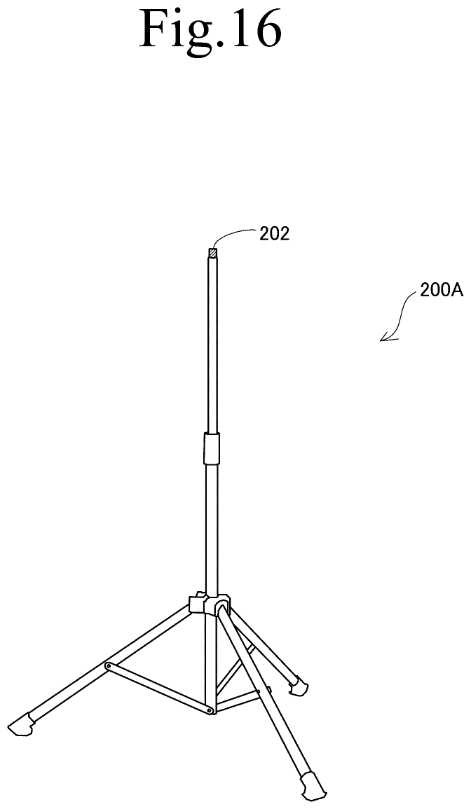

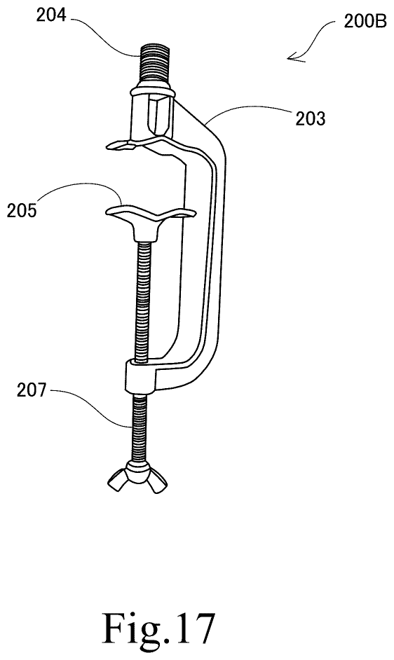

Usage of the female thread 38 of the fixing part 30 is now described with reference to FIGS. 16 and 17. The female thread 38 as shown in FIG. 12 is used to fix the lighting device 100 to an installation object or an installation accessory. The “installation accessory” means a device or a tool for fixing the lighting device 100 to an installation object.

An installation accessory such as a so-called tripod 200A as shown in FIG. 16 can be fitted to the female thread 38. Methods for installing the lighting device 100 are increased by using such an installation accessory. The lighting device 100 is fixed to the tripod 200A by screwing the female thread 38 onto a male thread 202 formed on an upper end of the tripod 200A.

An installation accessory such as a so-called clamp 200B as shown in FIG. 17 can also be fitted to the female thread 38. The clamp 200B has a male thread 204, a body 203, a support part 205 and an adjustment part 207 for adjusting the position of the support part 205. The lighting device 100 is fixed to the clamp 200B by screwing the male thread 204 into the female thread 38. The installation object is then clamped between the body 203 and the support part 205 of the clamp 200B by adjusting the position of the support part 205 using the adjustment part 207, so that the lighting device 100 is fixed to an installation object by the clamp 200B. The installation accessories are not limited to the tripod 200A and the clamp 200B, but other kinds of installation accessories may be used.

### A4. Effects

As described above, in the lighting device 100 of this embodiment, the second base 20 is arranged on the upper side of the first base 10. The battery mounting part 40 is configured such that the battery BT mounted to the battery mounting part 40 is arranged on the upper side of the first base 10. The connecting member 60 connects the lighting part 70 and the second base 20 such that the lighting part 70 can be rotated around the first rotational axis AX1, and is arranged above the battery BT mounted to the battery mounting part 40. By arranging the battery BT on the upper side of the first base 10 together with the second base 20, the first and second bases 10, 20 protect the battery BT, so that protection of the battery BT is enhanced. Further, by arranging the connecting member 60 defining the first rotational axis AX1 above the battery BT, the lighting part 70 is avoided from interfering with the battery BT when the lighting part 70 is rotated around the first rotational axis AX1 and the second rotational axis AX2, so that the rotatable range of the lighting part 70 is widened. Thus, the light irradiation range of the lighting device 100 is expanded.

In the lighting device 100 of this embodiment, the battery mounting part 40 is arranged on the first base 10. The battery BT mounted to the battery mounting part 40 is arranged apart from the connecting member 60 that connects the lighting part 70 and the second base 20. Thus, the lighting part 70 is avoided from interfering with the battery BT when the lighting part 70 is rotated around the first rotational axis AX1 and the second rotational axis AX2, so that the rotatable range of the lighting part 70 is widened.

In the lighting device 100 of this embodiment, the fixing part 30 that is configured to be fixed to the installation object OB or an installation accessory is provided on the lower side of the first base 10. Thus, the lighting device 100 is provided that can be easily fixed on the installation object OB and is highly convenient for a user.

In the lighting device 100 of this embodiment, the battery mounting part 40 is arranged on the opposite side of the first base 10 to the fixing part 30. Thus, the battery BT is arranged on the side opposite to the fixing part 30, so that contact between the battery BT and the installation object OB is avoided or prevented.

In the lighting device 100 of this embodiment, the first base 10 extends in the first extending direction ED1 orthogonal to the second extending direction ED2 of the second base 20. With this arrangement of the first and second bases 10, 20 orthogonal to each other, the body of the lighting device 100 is formed in a generally rectangular (cuboid) shape so as to be reduced in size. Further, the lighting device 100 formed in a generally rectangular (cuboid) shape is improved in designability.

In the lighting device 100 of this embodiment, the lighting part 70 is further configured to be rotated around the second rotational axis AX2 orthogonal to the first rotational axis AX1. By provision of the lighting part 70 configured to be rotated around a plurality of rotational axes, the light irradiation range of the lighting device 100 is expanded.

In the lighting device 100 of this embodiment, the lighting part 70 has the light emitting surface 72 for emitting light. The position of the light emitting surface 72 is changeable between the first position in which the light emitting surface 72 is covered by the second base 20 and the second position in which the whole of the light emitting surface 72 is exposed to the outside of the lighting device 100. The lighting device 100 is placed in the OFF state when the light emitting surface 72 is placed in the first position to be covered by the second base 20, so that the lighting device 100 in the OFF state is made compact in size. Thus, the lighting device 100 is provided that can be easily stored when not in use and is highly convenient.

In the lighting device 100 of this embodiment, the lighting part 70 extends in the third extending direction ED3 away from the connecting part between the lighting part 70 and the second base 20, in a view from the left-right direction of the lighting device 100. The width W3 of the lighting part 70 in the third extending direction ED3 is shorter than the width W1 of the first base 10 in the first extending direction ED1. The lighting part 70 that is a rotatable part in the lighting device 100 is formed smaller than the body of the lighting device 100, so that the lighting device 100 is provided that is highly convenient even for use in a small space.

In the lighting device 100 of this embodiment, the power switch button SW is arranged on the left side surface 75 of the housing 76. Thus, the lighting device 100 is provided that allows a user to perform both the operations of turning on and off the lighting part 70 and rotating the lighting part 70 while holding the housing 76, and is highly convenient.

In the lighting device 100 of this embodiment, the grip part 54 is arranged in an area between the lower end of the first base 10 and the first rotational axis AX1 in the up-down direction in an area on the opposite side of the second base 20 to the battery BT mounted to the battery mounting part 40 in a view from the left-right direction of the lighting device 100. By the arrangement of the grip part 54 on the front side of the lighting device 100, the lighting device 100 is provided that is easy to hold and highly convenient.

In the lighting device 100 of this embodiment, the grip part 54 is arranged in a position to be prevented from interfering with the lighting part 70 that is rotated around the first rotational axis AX1. Thus, the rotation range of the lighting part 70 is avoided from being reduced due to the existence of the grip part 54, while the grip part 54 is arranged on the front side of the lighting device 100.

In the lighting device 100 of this embodiment, the first base 10, the second base 20 and the lighting part 70 all have a cuboid shape. The first base 10, the second base 20 and the lighting part 70 can be each reduced in size to reduce the size of the lighting device 100. Further, by using a cuboid member for each part of the lighting device, the lighting device 100 is provided with high designability.

### B. SECOND EMBODIMENT

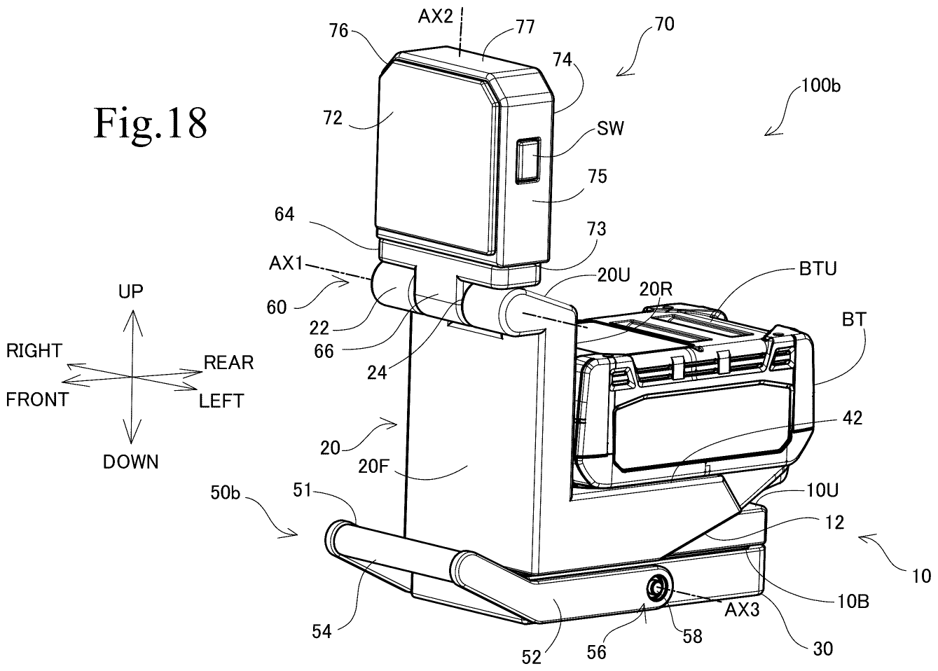

A lighting device 100b according to a second embodiment is now described with reference to FIGS. 18 to 20. As shown in FIG. 18, the lighting device 100b of the second embodiment is different from the lighting device 100 of the first embodiment in that a rotary handle 50b is provided in place of the handle 50, but in the other points, the lighting device 100b has the same structure as the lighting device 100 of the first embodiment. The handle 50b can be rotated around a third rotational axis AX3 shown in FIG. 18 so that the position of the grip part 54 can be freely changed.

As shown in FIG. 18, the handle 50b has base parts 51, 52, a grip part 54, connecting parts 56 and a shaft part 58. The base parts 51, 52 are connected to the shaft part 58 via the connecting parts 56. The shaft part 58 is inserted through a through hole formed in the fixing part 30. The through hole is substantially parallel to the left-right direction and defines the third rotational axis AX3. Thus, the grip part 54 of the handle 50b is connected to the fixing part 30 so as to be rotated around the third rotational axis AX3 relative to the fixing part 30. The rotational position of the grip part 54 around the third rotational axis AX3 can be fixed by a fixture (not shown).

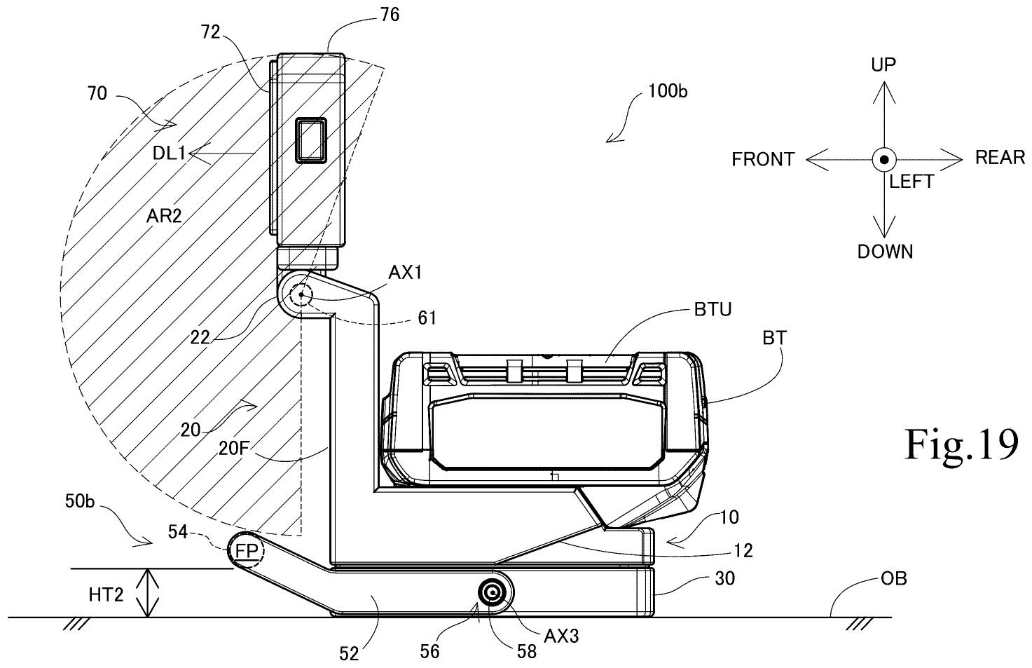

For example, as shown in FIG. 19, the grip part 54 can be placed in a front grip position FP. The handle 50b is restricted from being rotated clockwise from the front grip position FP by abutment of an upper end of the base part 52 on the first base 10.

The “front grip position FP” is a position of the grip part 54 placed in front of the second base 20. In this embodiment, this position is substantially identical to the arrangement position of the grip part 54 of the handle 50 of the first embodiment. When placed in the front grip position FP, the grip part 54 is located at a predetermined height HT2 from the lower surface of the fixing part 30. Thus, a user can easily insert fingers between the installation object OB and the grip part 54 and easily hold the grip part 54.

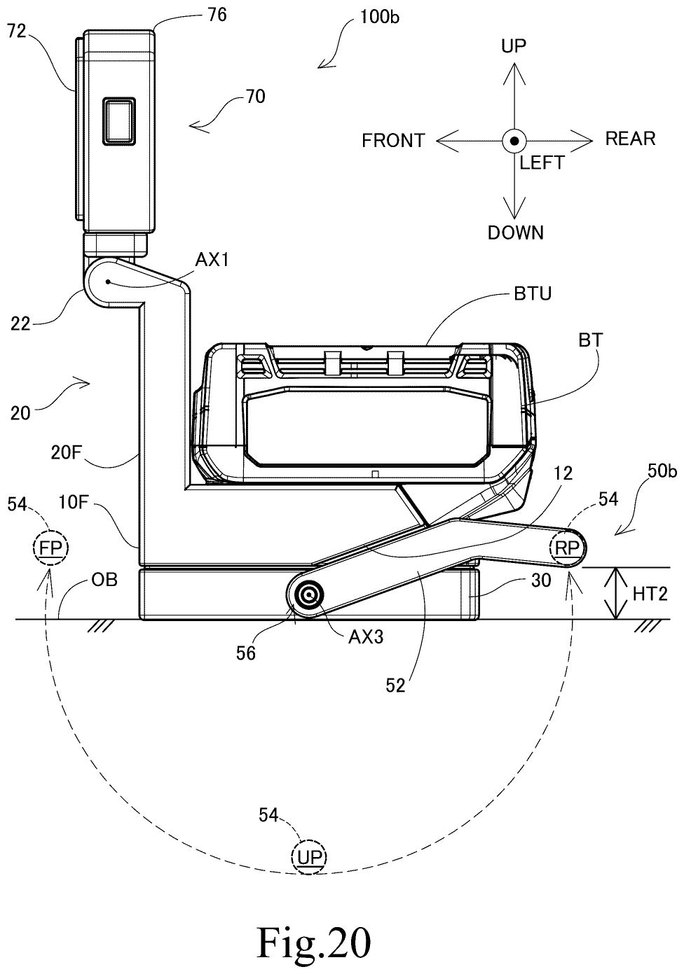

As shown in FIG. 20, the grip part 54 can be placed in a rear grip position RP by turning the handle 50b counterclockwise until the handle 50b abuts on a restriction part 12. The “rear grip position RP” is a position of the grip part 54 located behind the second base 20 and the first base 10. The rear grip position RP is located on the side opposite to the front grip position FP across the second base 20. The rear grip position RP can be set to any position by the restriction part 12. In this embodiment, the rear grip position RP is a line-symmetrical position to the front

grip position FP with respect to the up-down direction passing the third rotational axis AX3 in a view from the left-right direction of the lighting device 100b. Thus, when placed in the rear grip position RP, the grip part 54 is also located at the height HT2 from the lower surface of the fixing part 30. Therefore, the lighting device 100 is provided that is easy to hold even when the grip part 54 is placed in the rear grip position RP, and is highly convenient.

Further, as shown in FIG. 20, the grip part 54 can be fixed at any position between the rear grip position RP and the front grip position FP by turning the handle 50b. For example, the grip part 54 can be placed in a lower grip position UP below the first base 10. The grip part 54 placed in the lower grip position UP can be hooked to an installation object such as a hook and a rod-like member to hung the handle 50b to the installation object.

In the lighting device 100b of this embodiment, the grip part 54 of the handle 50b is connected to the fixing part 30 of the first base 10 so as to be rotated around the third rotational axis AX3 relative to the fixing part 30. The position of the grip part 54 can be changed between the front grip position FP located in front of the second base 20 and the rear grip position RP located behind the second base 20 by rotating around the third rotational axis AX3. Therefore, the position of the grip part 54 can be changed, for example, according to the direction of the light emitting surface 72 or the installation position of the lighting device 100b. Thus, the lighting device 100b is provided with high convenience for a user. In this embodiment, the grip part 54 of the handle 50b is connected to the fixing part 30, but it may be connected to a part other than the fixing part 30, such as the first base 10 and the second base 20.

### C. THIRD EMBODIMENT

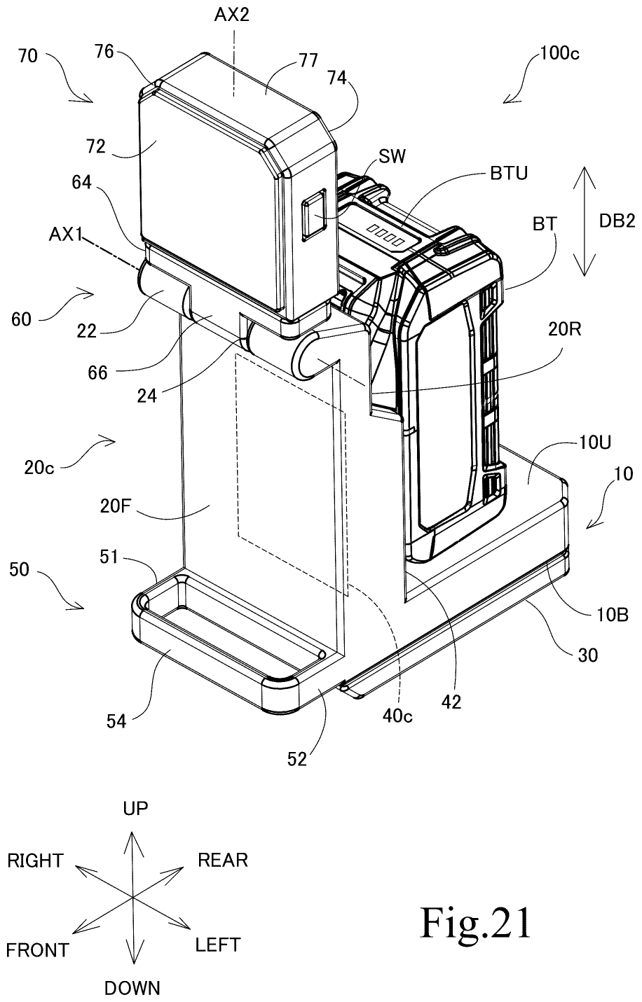

A lighting device 100c according to a third embodiment is now described with reference to FIGS. 21 to 23. The lighting device 100c of the third embodiment is different from the lighting device 100 of the first embodiment in that a second base 20c is provided in place of the second base 20 and a battery mounting part 40c is provided in place of the battery mounting part 40 arranged on the upper surface 10U of the first base 10 and arranged in a different position, but in the other points, the lighting device 100c has the same structure as the lighting device 100 of the first embodiment.

The second base 20c is different from the second base 20 of the first embodiment in that the battery mounting part 40c is formed on the rear surface 20R. The battery mounting part 40c is different from the battery mounting part 40 in that it is formed on the rear surface 20R of the second base 20 and defines a mounting/removing direction DB2 of the battery BT.

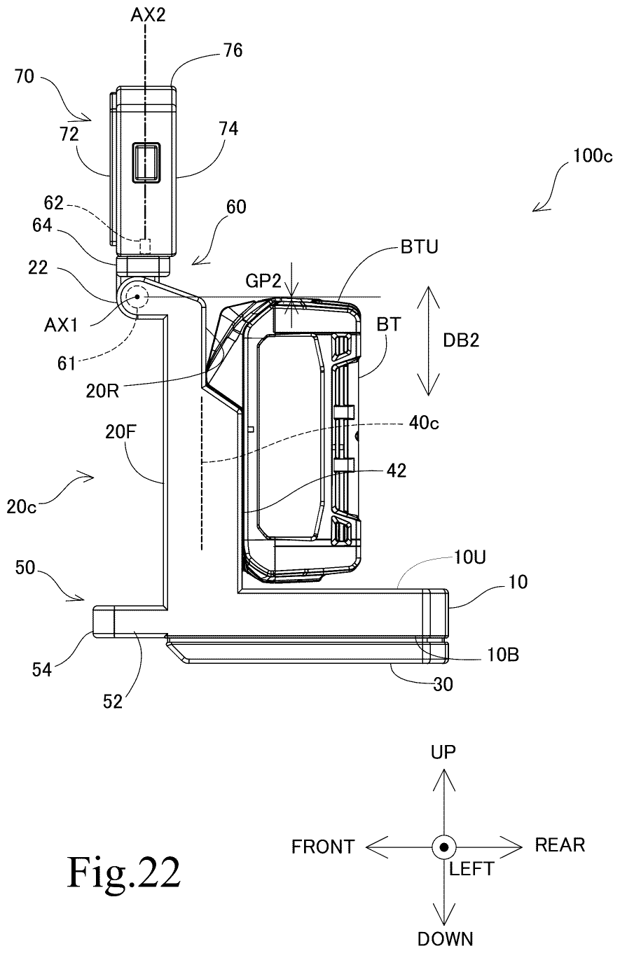

As shown in FIG. 22, the mounting/removing direction DB2 of the battery BT is parallel to the second extending direction ED2 of the second base 20c, and in this embodiment, parallel to the up-down direction. The mounting/removing direction of the battery BT may however be parallel to the left-right direction.

A user can remove the battery BT from the battery mounting part 40c by pulling out the battery BT upward along the mounting/removing direction DB. Further, a user can mount the battery BT to the battery mounting part 40c by pushing in the battery BT downward along the mounting/removing direction DB. The battery mounting part 40c may be arranged not on the first base 10 but on the second base 20 in this manner.

The battery BT mounted to the battery mounting part 40c is arranged on the upper side of the first base 10. In an example shown in FIG. 22, the battery BT mounted to the battery mounting part 40c is fixed in proximity to the upper surface 10U of the first base 10. The battery BT need not be in contact with the first base 10. Like in the first embodiment, with this arrangement of the battery BT on the upper side of the first base 10, the battery BT is protected by the first and second bases 10, 20, so that protection of the battery BT is enhanced. Further, the bent body covers the battery BT from two directions, thereby efficiently avoiding or preventing contact between the battery BT and an installation object.

In the first embodiment, the whole of the connecting member 60 is arranged above the battery BT, but like in the lighting device 100c shown in FIG. 22, a part of the connecting member 60 that defines the first rotational axis AX1 may be arranged above the battery BT. Thus, the “connecting part between the lighting part and the second base” may be a part of the connecting member 60 that defines the first rotational axis AX1. In this case, as shown in FIG. 22, a gap GP2 is provided in the up-down direction between the upper end BTU of the battery BT and the part of the connecting member 60 that defines the first rotational axis AX1. In other words, the part of the connecting member 60 that defines the first rotational axis AX1 is arranged above the upper end BTU of the battery BT. Even with such a configuration, the lighting part 70 is avoided or prevented from interfering with the battery BT when rotated.

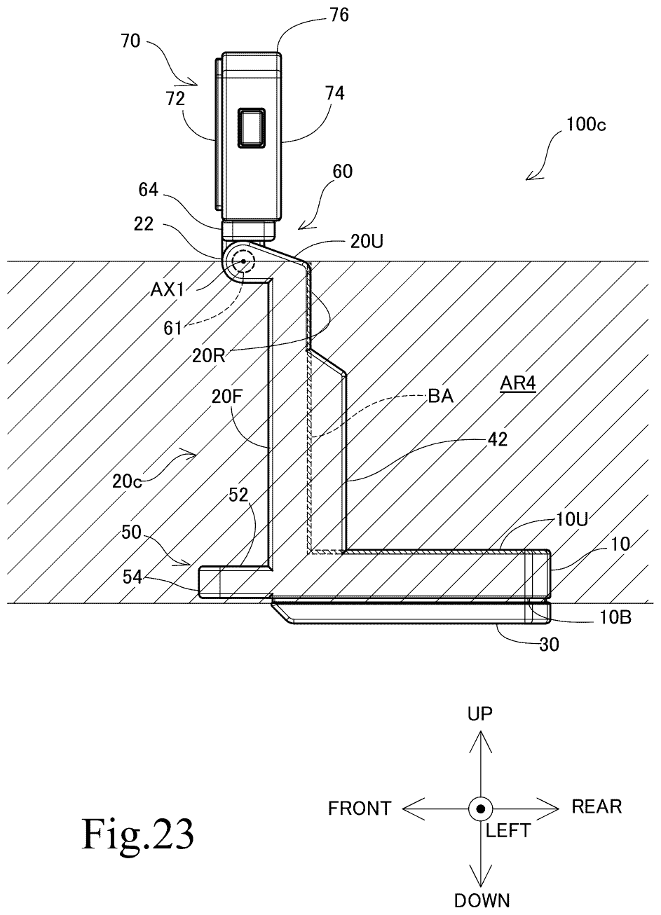

In FIG. 23, an area BA in which the battery mounting part 40c can be arranged is shown by hatching. As shown in FIG. 23, the battery mounting part 40c may be arranged, for example, in an area AR4 between the fixing part 30 and the upper end (the upper surface 20U in the example of FIG. 23) of the second base 20 in the up-down direction. The battery mounting part 40c is preferably arranged, for example, on the upper surface 10U of the first base 10 or the rear surface 20R of the second base 20, in the area AR4 as shown by the hatched area BA.

### D. FOURTH EMBODIMENT

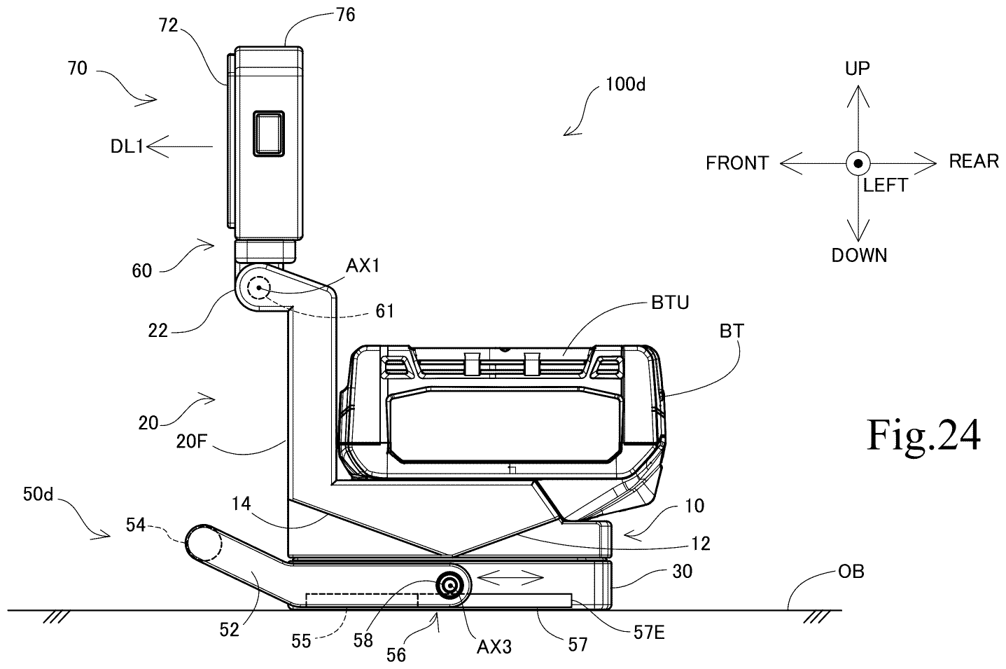

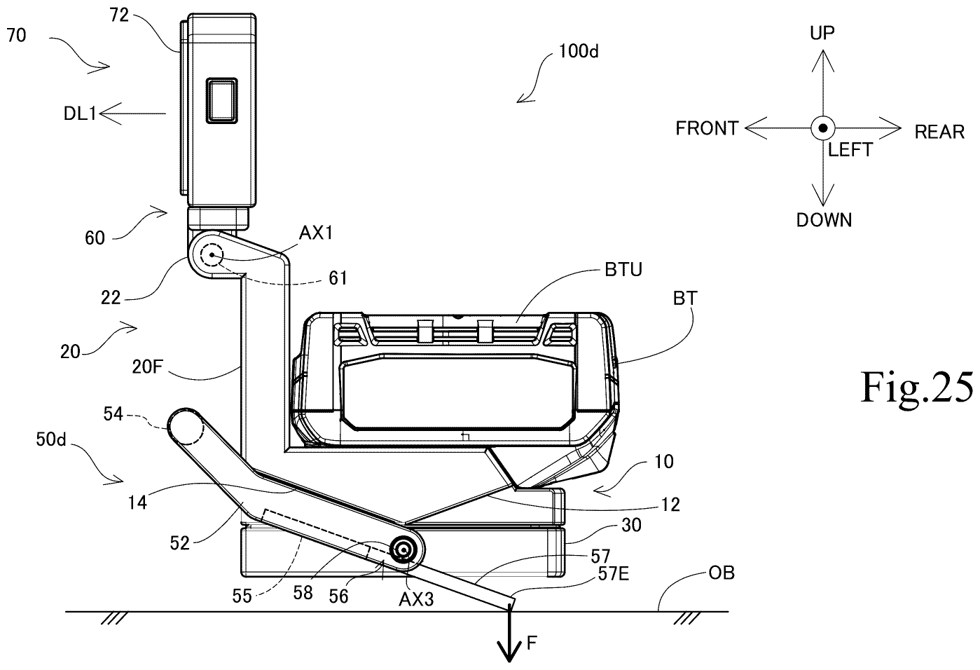

A lighting device 100d according to a fourth embodiment is now described with reference to FIGS. 24 and 25. The lighting device 100d of the fourth embodiment is different from the lighting device 100 of the first embodiment in that a handle 50d is provided in place of the handle 50, but in the other points, it has the same structure as the first embodiment.

The handle 50d is different from the handle 50b of the second embodiment in that the handle 50d has a storing part 55 and a stick 57 in addition to the same structure as the handle 50b. Like in the handle 50b of the second embodiment, the handle 50d is connected to the fixing part 30 via the connecting parts 56 and the shaft part 58 so as to be rotated around the third rotational axis AX3 relative to the fixing part 30.

The stick 57 is an elongate member extending in the extending direction of the base part 52. The stick 57 is connected to the base part 52. The stick 57 is rotated together with the base part 52 when the handle 50d is rotated around the third rotational axis AX3.

The storing part 55 is a space that is formed in the base part 52 to store the stick 57. A user can freely change the position of the stick 57 between a stored position in which the stick 57 is stored in the storing part 55 and a protruded position in which the stick 57 is protruded from the storing part 55, by taking (sliding) the stick 57 into and out of the storing part 55. The handle 50d has the same function as the handle 50b of the second embodiment when the stick 57 is stored.

When a user lifts the grip part 54 placed in a rotatable position while the stick 57 is protruded from the storing part 55, as shown in FIG. 25, the grip part 54 of the handle 50d is rotated clockwise around the third rotational axis AX3 relative to the fixing part 30. The grip part 54 of the handle 50d is rotated until the handle 50d abuts on a restriction part 14. When the grip part 54 of the handle 50d is rotated around the third rotational axis AX3, a downward force Fis applied to the installation object OB with a tip end 57E of the stick 57 as the point of action by the rotation around the third rotational axis AX3 as a fulcrum. Thus, the user can lift the lighting device 100d from the installation object OB with a relatively small force by the principle of leverage utilizing rotation of the handle 50d. Therefore, even if the lighting device 100d is, for example, firmly fixed to the installation object OB by the magnet 32, the user can lift the lighting device 100d from the installation object OB with a relatively small force.

### E. FIFTH EMBODIMENT

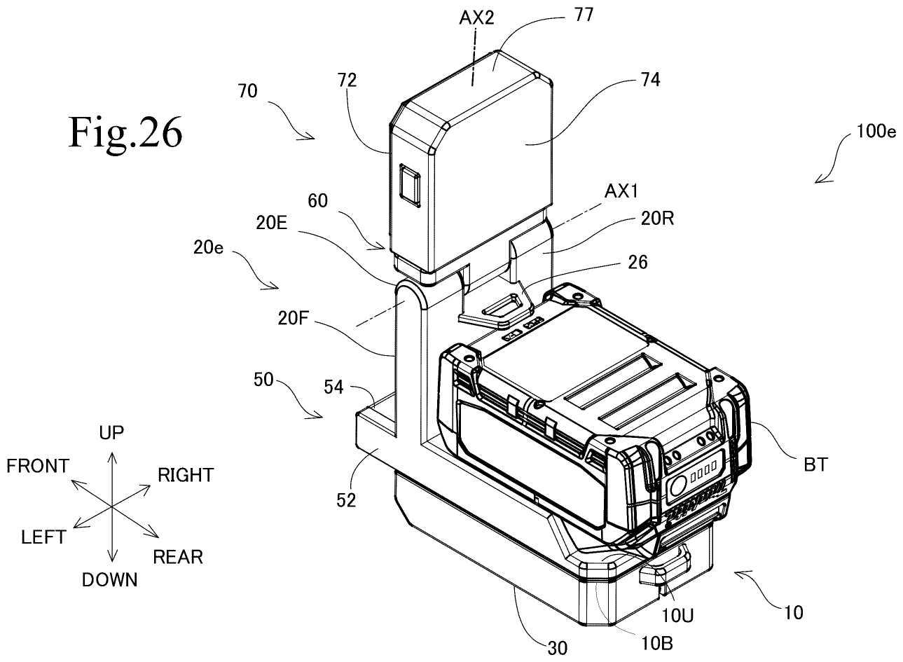

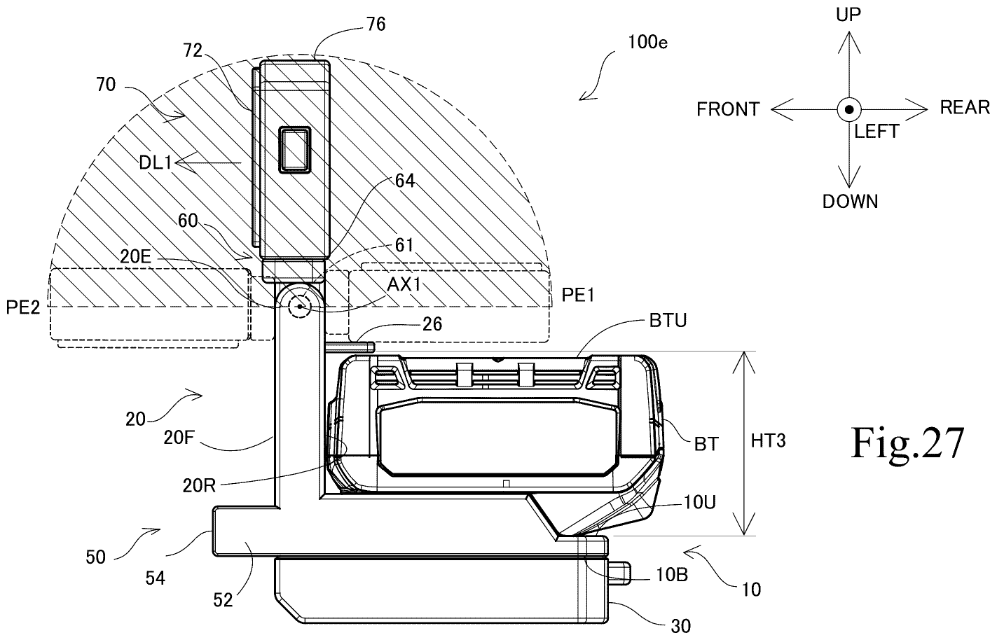

A lighting device 100e according to a fifth embodiment is now described with reference to FIGS. 26 and 27. The lighting device 100e of the fifth embodiment is different from the lighting device 100 of the first embodiment in that a second base 20e is provided in place of the second base 20, but in the other points, it has the same structure as the first embodiment. The second base 20e is different from the second base 20 of the first embodiment in that the second base 20e does not have the bent part 22 and has a projection 26, but in the other points, it has the same structure as the second base 20.

The projection 26 protrudes rearward from the rear surface 20R of the second base 20e. In this embodiment, the projection 26 has a generally flat plate-like shape, but it may have other shapes such as a rod-like shape protruding rearward from the rear surface 20R.

As shown in FIG. 27, the projection 26 is arranged at a height HT3 from the upper surface 10U of the first base 10, and the height HT3 is set to be higher than the height of the battery BT mounted to the battery mounting part 40. Specifically, the projection 26 is arranged above the upper end BTU of the battery BT mounted to the battery mounting part 40. With this configuration, the height of the battery BT mounted to the battery mounting part 40 is limited up to the height HT3 of the projection 26.

The battery BT recommended for use in the lighting device 100e is, for example, a 36 V battery having a battery capacity of 4.0 to 5.0 Ah. The battery BT having a voltage and a battery capacity larger than the recommended values, such as a 36 V battery having a battery capacity of 8.0 Ah, is larger in size than the battery BT recommended for use in the lighting device 100e. Such a larger battery BT is prevented from being mounted to the battery mounting part 40 by the presence of the projection 26. The projection 26 also serves as a restriction part that restricts clockwise rotation of the lighting part 70 as shown in FIG. 27.

As shown in FIG. 27, the second base 20e does not have the bent part 22. In this embodiment, the connecting member 60 is connected to an upper end part 20E of the second base 20e instead of the bent part 22. The rotation range of the lighting part 70 around the first rotational axis AX1 is limited by the front surface 20F and the rear surface 20R. Specifically, the position of the lighting part 70 can be adjusted in the rotation range between a position PE1 in which the base part 64 of the connecting member 60 abuts on the rear surface 20R and a position PE2 in which the base part 64 abuts on the front surface 20F. In the position PE1, the light emitting surface 72 faces the upper end BTU of the battery BT, so that protection of the battery BT and the light emitting surface 72 is enhanced. The rotation range of the lighting part 70 relative to the second base 20e can be freely adjusted by adjusting the shape of the connecting part between the second base 20e and the connecting member 60 as described above.

### F. SIXTH EMBODIMENT

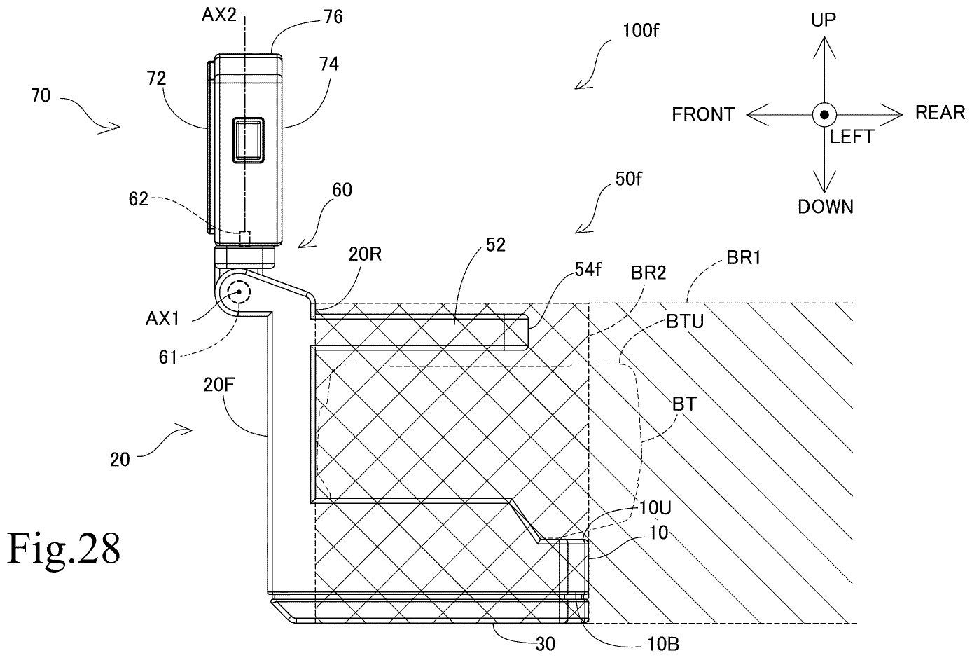

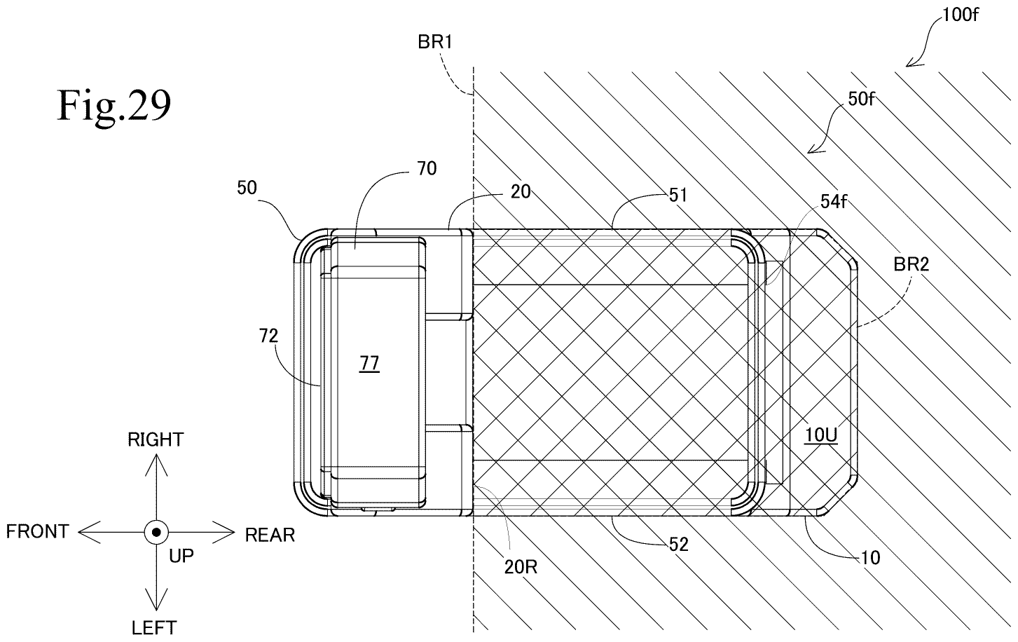

A lighting device 100f according to a sixth embodiment is now described with reference to FIGS. 28 and 29. The lighting device 100f of the sixth embodiment is different from the lighting device 100 of the first embodiment in that a handle 50f is provided in place of the handle 50 and protrudes rearward from the rear surface 20R of the second base 20, but in the other points, it has the same structure as the first embodiment.

In FIGS. 28 and 29, for ease of technical understanding, a rear area BR1 of the lighting device 100f is shown by hatching. As shown in FIGS. 28 and 29, a grip part 54f is arranged in the rear area BR1 of the lighting device 100f. The “rear area BR1” is an area behind the second base 20 in a view from the left-right direction of the lighting device 100f, and extending from the lower end of the first base 10 (the lower surface of the fixing part 30 in this embodiment) to the connecting member 60 between the lighting part 70 and the second base 20 in the up-down direction. The rear area BR1 includes, for example, the rear grip position RP shown in FIG. 20. In the lighting device 100f having such a structure, the number of parts to be arranged in front of the second base 20 is reduced, so that the structure of the front part of the lighting device 100f can be simplified. Thus, the lighting device 100f is provided with high designability.

In FIGS. 28 and 29, for ease of technical understanding, an area BR2 is shown by cross hatching. In this embodiment, the grip part 54f is arranged in the area BR2 that overlaps with the first base 10 in the rear area BR1 in a top view of the first base 10. In this embodiment, the grip part 54f is arranged above the first base 10 in the area BR2. In the lighting device 100f having such a structure, the grip part 54f is arranged in the vicinity of the battery BT, so that the lighting device 100f can be reduced in size.

In this embodiment, like the projection 26 (see FIG. 27) of the fifth embodiment, the grip part 54f is arranged above the upper end BTU of the battery BT mounted to the battery mounting part 40. With this configuration, the grip part 54f functions similarly to the projection 26 so that the size of the battery BT to be mounted to the battery mounting part 40 is limited.

In the example shown in FIGS. 28 and 29, the handle 50f is fixed to the second base 20, but a rotary handle like the handle 50b of the second embodiment may be used provided that the grip part 54f is arranged in the rear area BR1 and the area BR2. Further, the base parts 51, 52 may be arranged in an area other than the rear area BR1 and the area BR2, provided that the grip part 54f is arranged in the rear area BR1 and the area BR2. In the example shown in FIGS. 28 and 29, the base parts 51, 52 are connected to the second base 20, but they may be connected to the first base 10 provided that the grip part 54f is arranged in the rear area BR1 and the area BR2.

### G. SEVENTH EMBODIMENT

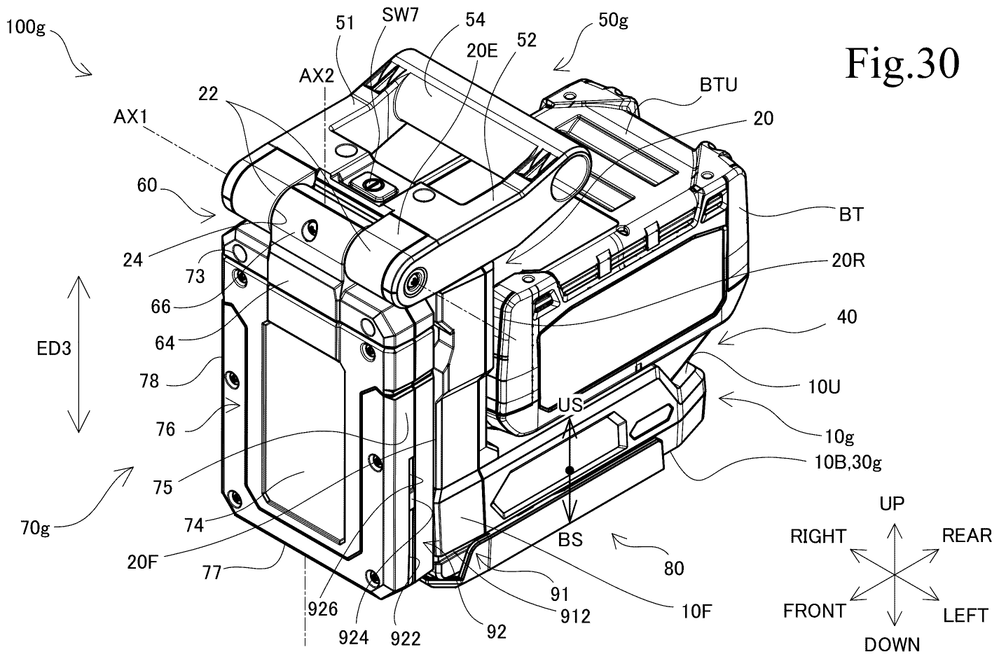

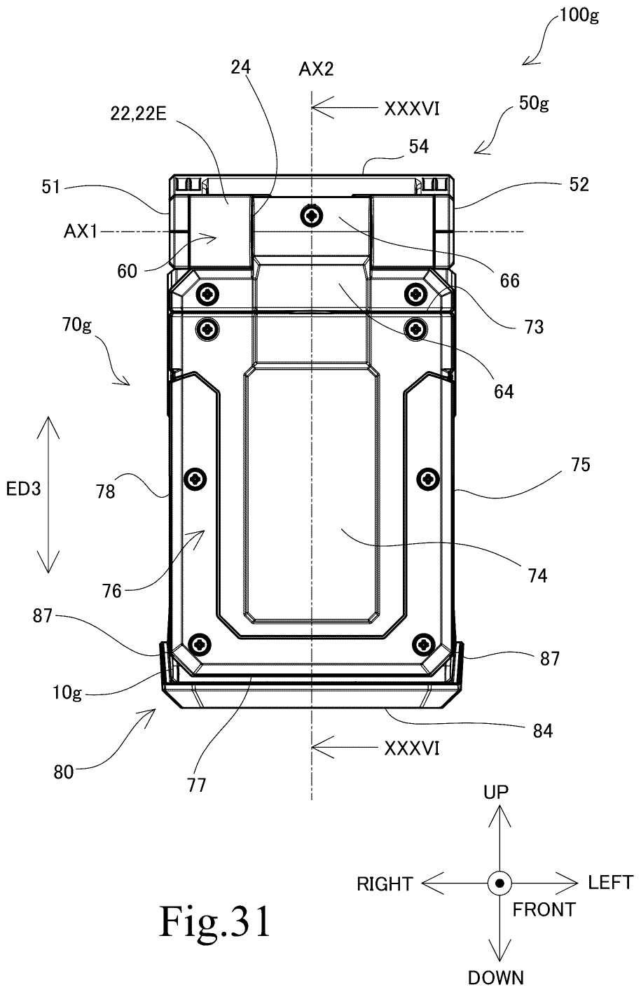

A lighting device 100g according to a seventh embodiment is now described with reference to FIGS. 30 to 45. The lighting device 100g of the seventh embodiment is different in structure from the lighting device 100 of the first embodiment, for example, in that a first base 10g, a handle 50g, a fixing part 30g and a lighting part 70g are provided in place of the first base 10, the handle 50, the fixing part 30 and the lighting part 70 and a cover 80 is removably provided, and in the arrangement of an operation switch SW7. The battery BT and the battery mounting part 40 are identical in structure to those of the first embodiment, and the mounting/removing direction DB of the battery BT is substantially parallel to the front-rear direction. The differences from the structure of the lighting device 100 of the first embodiment are now mainly described while the similarities are not described.

### G1. The Structure of the Lighting Part 70g

As shown in FIG. 30, the lighting part 70g is different from the lighting part 70 of the first embodiment in that a pair of second locking parts 92 are provided. The rotatable ranges of the lighting part 70g around the first and second rotational axes AX1, AX2 are different from those of the rotatable ranges of the lighting part 70.

### G1-1. The Structure of the Second Locking Part 92

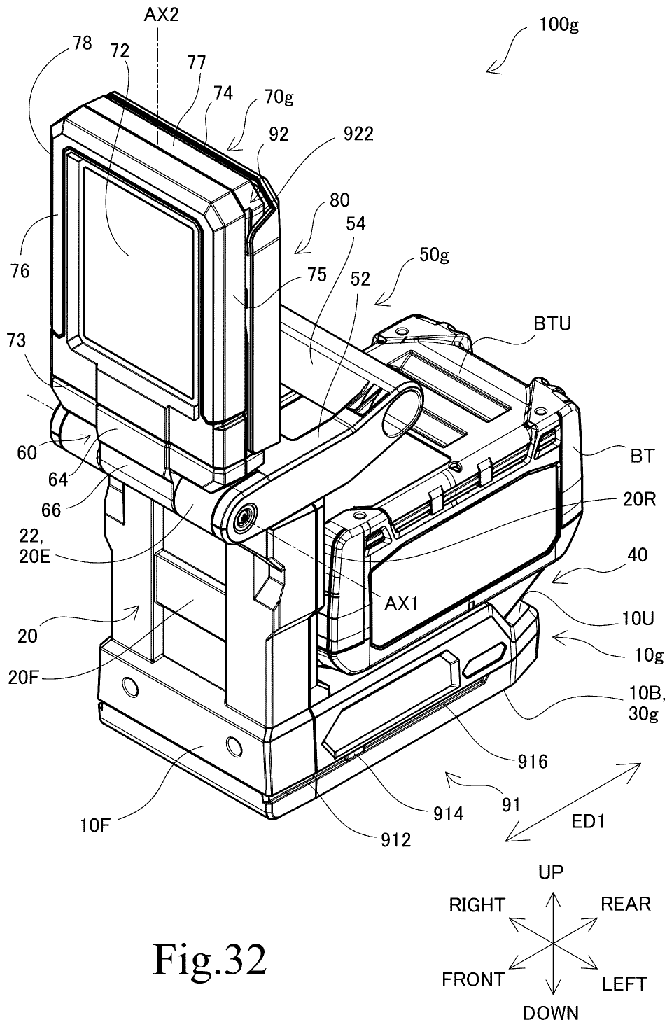

As shown in FIG. 32, the pair of second locking parts 92 are formed in the left and right side surfaces 75, 78 of the lighting part 70g, respectively. The second locking parts 92 are configured to be engaged with a pair of third locking parts 83 of the cover 80 as described below such that the cover 80 can be removably attached to the lighting part 70g. The second locking parts 92 formed in the left and right side surfaces 75, 78 have substantially the same structure, and therefore, the second locking part 92 formed in the left side surface 75 is described herein as an example.

As shown in FIG. 30, the second locking part 92 has a first groove 922, a trapezoidal part 924 and a second groove 926. The first and second grooves 922, 926 serve as a guide groove for guiding the third locking part 83 (more specifically, a first projection 832 and a second projection 833) of the cover 80.

The first groove 922 extends from the trapezoidal part 924 to an end on the upper side surface 77 side in both the left side surface 75 and the right side surface 78 along the third extending direction ED3 or the extending direction of the housing 76 of the lighting part 70g. The second groove 926 extends from the trapezoidal part 924 to the vicinity of the center of both the left side surface 75 and the right surface 78 along the third extending direction ED3.

The trapezoidal part 924 is formed between the first and second grooves 922, 926. The trapezoidal part 924 protrudes outward of the bottoms of the first and second grooves 922, 926. The trapezoidal part 924 has an inclined part that connects an end surface of the trapezoidal part 924 and the bottom of the first groove 922 and an inclined part that connects the end surface of the trapezoidal part 924 and the bottom of the second groove 926, on the both ends of the trapezoidal part 924 in the third extending direction ED3.

### G1-2. The Rotatable Range of the Lighting Part 70g

As shown in FIG. 32, the lighting part 70g is rotatably connected to an upper end part 20E of the second base 20 via the connecting member 60. Like in the first embodiment, the connecting member 60 has the base part 64 and the protruding part 66 protruding from the base part 64. The protruding part 66 has a shape conforming to the recess 24 defined between the bent parts 22 of the second base 20. The protruding part 66 is connected to the bent parts 22 so as to be rotated around the first rotational axis AX1 via a shaft (not shown). The lighting part 70g is connected to the base part 64 so as to be rotated around the second rotational axis AX2 via a shaft (not shown).

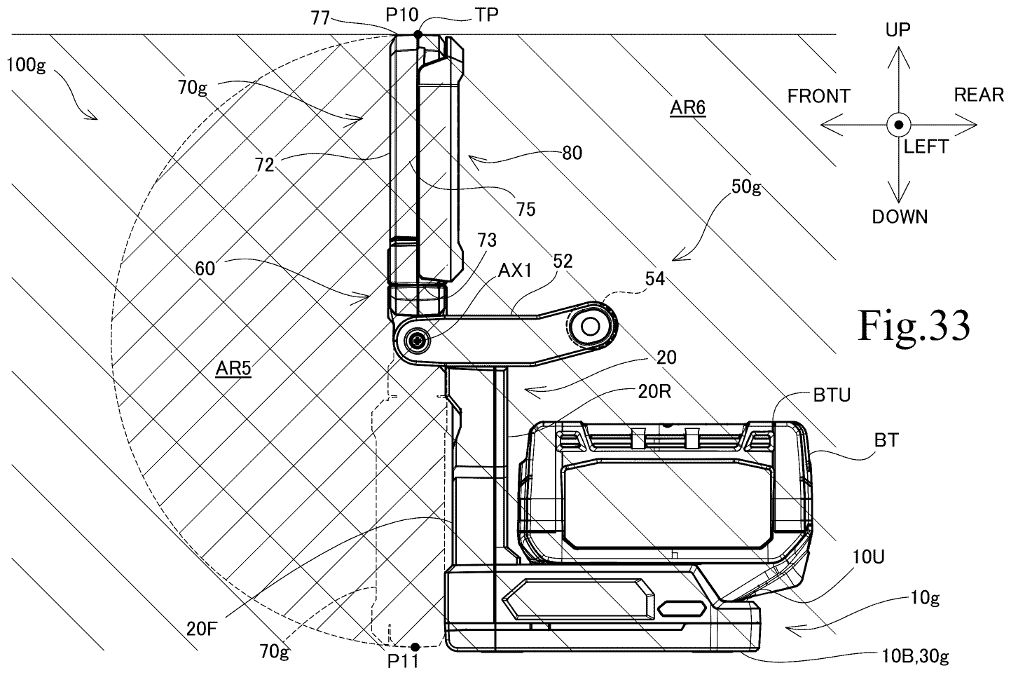

Rotation of the lighting part 70g around the first rotational axis AX1 is now described with reference to FIG. 33. As shown in FIG. 33, the position of the lighting part 70g can be changed to any position in the range from a position P10 to a position P11 by rotating the connecting member 60 around the first rotational axis AX1 relative to the second base 20. Even if the cover 80 is attached to the lighting part 70g as shown in FIG. 33, the lighting part 70g can be rotated in the same manner as when the cover 80 is not attached.

In the position P10, the lighting part 70g is located above the first rotational axis AX1, and the third extending direction ED3 and the second rotational axis AX2 are substantially parallel to the up-down direction. The position P11 is a position of the lighting part 70g rotated 180° from the position P10 around the first rotational axis AX1. In the position P11, the lighting part 70g is located below the first rotational axis AX1, and the third extending direction ED3 and the second rotational axis AX2 are substantially parallel to the up-down direction. Further, in the position P11, the lighting part 70g and the second base 20 face closest to each other.

In FIG. 33, a rotatable range AR5 of the lighting part 70g that is rotated around the first rotational axis AX1 is schematically shown by hatching in a side view of the lighting device 100g. The rotatable range AR5 means an area that the lighting part 70g occupies when rotated around the first rotational axis AX1. An uppermost end TP shown in FIG. 33 is the uppermost end of the rotatable range AR5. More specifically, the uppermost end TP is a position of an upper end of the lighting part 70g located in the position P10. An area AR6 shown in FIG. 33 is an area below the uppermost end TP.

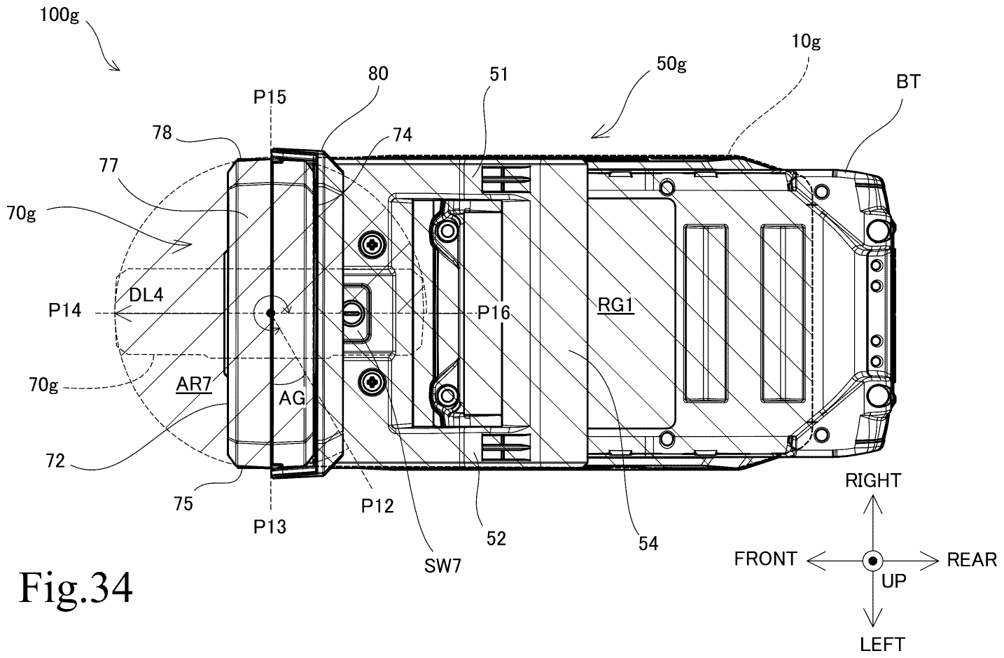

Rotation of the lighting part 70g around the second rotational axis AX2 is now described with reference to FIG. 34. In FIG. 34, a rotatable range AR7 of the lighting part 70g that is rotated around the second rotational axis AX2 is schematically shown by hatching in a top view of the lighting device 100g. In FIG. 34, for ease of understanding, the rotatable range AR7 is shown as a range in which a direction DLA of the light emitting surface 72 can be changed. In this embodiment, the direction DL4 of the light emitting surface 72 can be changed in the range of the rotation angle of 300° in directions including the front-rear direction and the left-right direction, within the rotatable range AR7.

As shown in FIG. 34, the position of the lighting part 70g can be changed to any position in the range from a position P12 to a position P16 by rotating the lighting part 70g around the second rotational axis AX2 relative to the connecting member 60. The position P13 is a position of the lighting part 70g in which the direction DL4 of the light emitting surface 72 is the left direction. The position P12 is a position of the lighting part 70g rotated 30° counterclockwise from the position P13. The position P14 is a position of the lighting part 70g in which the direction DL4 is the front direction. In FIGS. 32 and 33, the lighting device 100g is shown with the lighting part 70g placed in the position P14. In the position P15, the direction DLA is the right direction, and in the position P16, the direction DL4 is the rear direction.

### G1-3. Other Structures of the Lighting Part 70g

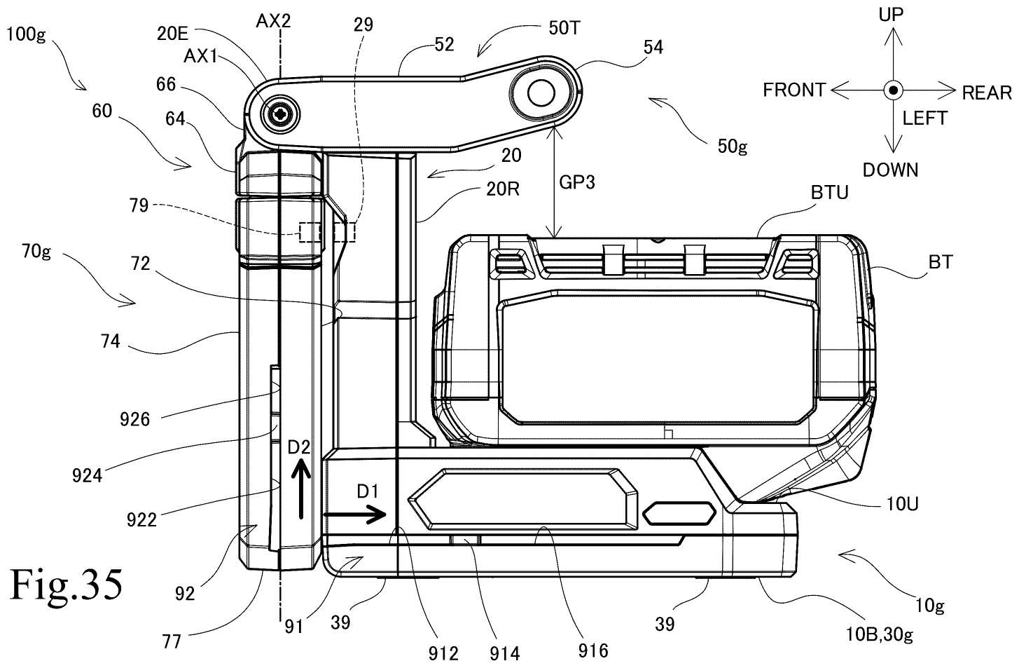

As shown in FIG. 35, in this embodiment, a magnet 79 is provided inside the lighting part 70g and a magnetic sensor 29 is provided in the second base 20. When the light emitting surface 72 is placed in the first position and covered by the front surface 20F of the second base 20, the magnetic sensor 29 detects magnetism of the magnet 79. The detection result of the magnetic sensor 29 is outputted to a controller 28.

### G2. The Structure of the First Base 10g

As shown in FIG. 32, the first base 10g is different from the first base 10 of the first embodiment in that a pair of first locking parts 91 are provided. The pair of first locking parts 91 are formed in the left and right side surfaces of the first base 10g, respectively. The first locking parts 91 are configured to be engaged with the third locking parts 83 of the cover 80 as described below such that the cover 80 can be removably attached to the first base 10g. The first locking parts 91 formed in the left and right side surfaces of the first base 10g have substantially the same structure, and therefore, the first locking part 91 formed in the left side surface is described herein as an example.

As shown in FIG. 32, the first locking part 91 has a first groove 912, a trapezoidal part 914 and a second groove 916. The first and second grooves 912, 916 serve as a guide groove for guiding the third locking part 83 (more specifically, the first projection 832 and the second projection 833) of the cover 80.

The first groove 912 extends from the trapezoidal part 914 to the front end 10F along the first extending direction ED1 (the front-rear direction) or the extending direction of the first base 10g, in both the left side surface and the right side surface of the first base 10g. The second groove 916 extends from the trapezoidal part 914 to a rear half part of the first base 10g along the first extending direction ED1.

The trapezoidal part 914 is formed between the first and second grooves 912, 916. The trapezoidal part 914 protrudes outward of the bottoms of the first and second grooves 912, 916. The trapezoidal part 914 has an inclined part that connects an end surface of the trapezoidal part 914 and the bottom of the first groove 912 and an inclined part that connects the end surface of the trapezoidal part 914 and the bottom of the second groove 916, on the front and rear ends of the trapezoidal part 914.

### G3. The Structure of the Handle 50g

As shown in FIGS. 30 and 35, the handle 50g is arranged at a different position from the handle 50 of the first embodiment. More specifically, in this embodiment, the handle 50g is non-rotatably connected to the upper end part 20E of the second base 20. The handle 50g includes a pair of base parts 51, 52 and a grip part 54.

Front end parts of the base parts 51, 52 are connected to the upper end part 20E of the second base 20 and extends rearward from the upper end part 20E of the second base 20. The grip part 54 extends in the left-right direction and is connected between rear end parts of the base parts 51, 52.

In FIG. 34, an area RG1 that the first base 10g occupies is shown by hatching in a top view of the lighting device 100g. As shown in FIG. 34, the whole of the grip part 54 is arranged in the area RG1 in the top view. Specifically, the grip part 54 overlaps with the first base 10g in the top view. By the arrangement of the grip part 54 just above the first base 10g, when the fixing part 30g of the lighting device 100g is placed on an installation object, a user can easily generate torque around the first base 10g and the fixing part 30g, and can separate the fixing part 30g from the installation object by applying a relatively small force to the grip part 54. Further, the handle 50g can be utilized to protect the battery BT mounted on the first base 10g. As shown in FIG. 33, the grip part 54 is preferably arranged in the area AR6 from the viewpoint of avoiding or preventing increase in size in the up-down direction of the lighting device 100g.

As shown in FIG. 35, in this embodiment, each of the base parts 51, 52 has a bent part 50T at which the extending direction of the base part 51, 52 changes. Each of the base parts 51, 52 extends linearly in the front-rear direction from the upper end part 20E of the second base 20 to the bent part 50T and extends obliquely upward from the bent part 50T to the grip part 54. Specifically, the grip part 54 is arranged further apart from the upper end BTU of the battery BT than the upper end part 20E of the second base 20. By this provision of a widened gap GP3 between the upper end BTU of the battery BT and the grip part 54, a user can easily insert fingers between the grip part 54 and the battery BT when holding the grip part 54. Thus, the lighting device 100g is provided with the grip part 54 easy to hold, while being reduced in size. The base parts 51, 52 may however be configured to extend linearly in the front-rear direction from the upper end part 20E of the second base 20 to the grip part 54, without having the bent part 50T. Further, the base parts 51, 52 may be connected not only to the upper end part 20E of the second base 20 but to any position between the lower end and the upper end of the second base 20.

### G4. The Structure of the Operation Switch SW7

As shown in FIG. 30, the operation switch SW7 is arranged on the upper end part 20E of the second base 20. A user can turn on and off the light emitting element of the lighting part 70g by manually operating the operation switch SW7 in one direction. The operation of “operating the operation switch SW7 in one direction” includes (i) a depressing operation in which at least part of the operation switch SW7 is depressed by a user and moved in a prescribed direction, and (ii) a touch operation in which a user moves a finger in a prescribed direction and touches the operation switch SW7, without moving the operation switch SW7 by user's operation. The operation switch SW7 includes a tactile switch, a push momentary switch, a rocker switch (also referred to as a see-saw switch) and a membrane switch. It may be a capacitive touch switch, a resistive touch switch or a pressure touch switch.

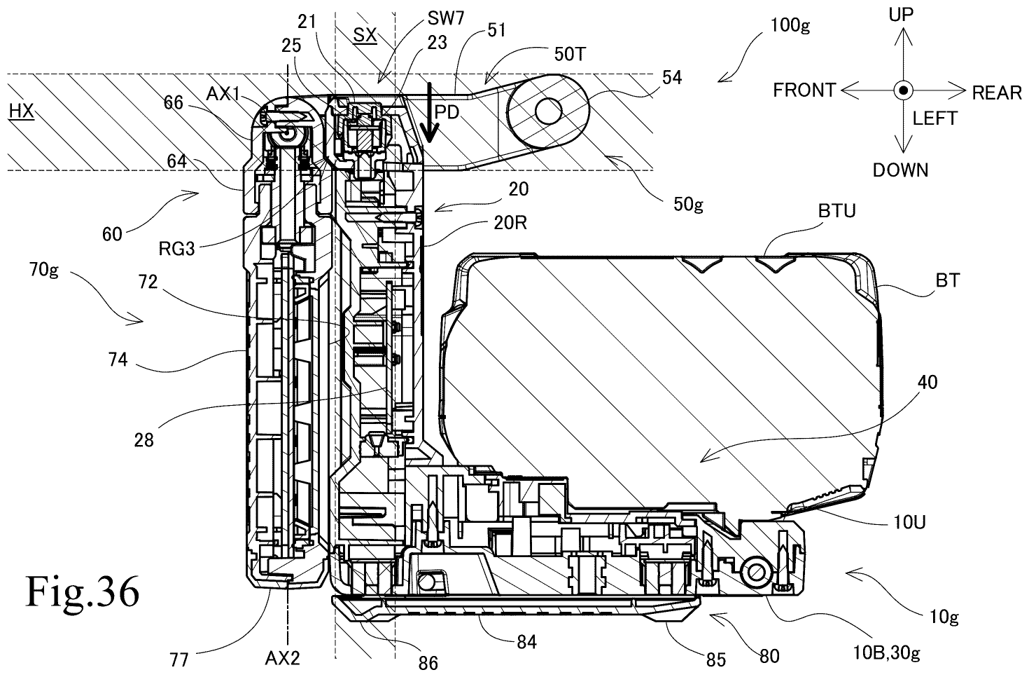

As shown in FIG. 36, the operation switch SW7 includes a plunger 21, a switch 23 and a circuit board 25, which are mainly housed in the second base 20.

The switch 23 is mounted on the circuit board 25. The switch 23 is a so-called alternate switch, and is turned on when depressed while being turned off when depressed again. The circuit board 25 is electrically connected to the controller 28 housed in the second base 20, via a lead wire (not shown). The switch 23 may be a so-called momentary switch that is turned on only while the switch 23 is depressed.

The plunger 21 is exposed to the outside of the second base 20. As shown by a depressing direction PD in FIG. 36, the plunger 21 is configured to be depressed downward from the outside of the lighting device 100g by user's depressing operation. When the plunger 21 is depressed, the switch 23 is depressed, and a signal for turning on or off the light emitting element is outputted to the controller 28 via the circuit board 25 and the lead wire.

The controller 28 includes a CPU as a processor for controlling turning on and off of the light emitting element according to the on-off operation of the switch 23, a storage device such as a RAM and a ROM, and a circuit board mounted with a switching element that is operated based on a control signal from the CPU. The controller 28 executes functions to be performed by the lighting device 100g of this embodiment when the CPU reads out and executes programs stored in the memory. The controller 28 may be configured to adjust the illuminance of light emitted from the lighting part 70g.

In this embodiment, the controller 28 further obtains the detection results of the magnetism of the magnet 79 from the magnetic sensor 29. When the magnetism of the magnet 79 is detected, the controller 28 turns off the light emitting element regardless of the on-off operation of the switch 23. With this structure, the light emitting element is automatically turned off when the light emitting surface 72 is placed in the first position and covered by the front surface 20F. Thus, the power consumption of the lighting device 100g is reduced or prevented

In FIG. 36, an axis SX is shown. The axis SX is parallel to the downward direction or the depressing direction PD of the operation switch SW7 and passes through the operation switch SW7. In this embodiment, the axis SX is arranged to cross the first base 10g and pass through the first base 10g. In other words, the operation switch SW7 is configured to be depressed in a direction toward the first base 10g. The operation switch SW7 can be depressed in the direction toward the fixing part 30g and the first base 10g that is exclusively placed on an installation object, so that the lighting device 100g can be held stably on the installation object while the operation switch SW7 is operated (depressed).

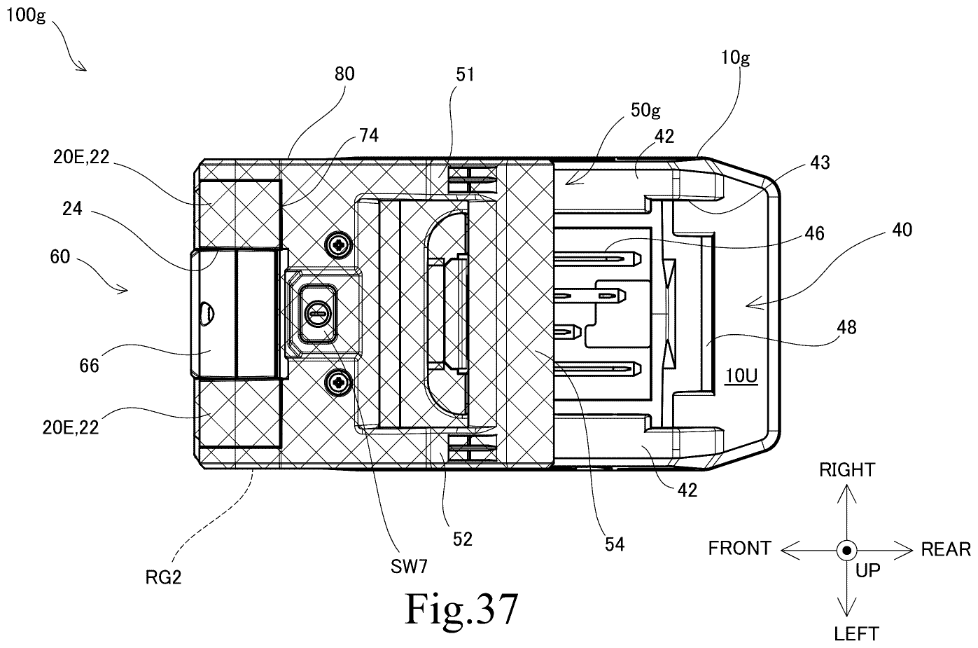

In this embodiment, the operation switch SW7 is arranged in an area surrounded by the second base 20, the base parts 51, 52 and the grip part 54. The “area surrounded by the second base 20, the base parts 51, 52 and the grip part 54” means an area that is three-dimensionally surrounded by the second base 20, the base parts 51, 52 and the grip part 54, or an area that is surrounded by the second base 20, the base parts 51, 52 and the grip part 54 in a top view and a side view. In FIG. 37, an area RG2 that is surrounded by the second base 20, the base parts 51, 52 and the grip part 54 is shown by cross hatching in the top view of the lighting device 100g. The area RG2 means a contour defined by the second base 20, the base parts 51, 52 and the grip part 54 in the top view of the lighting device 100g. In FIG. 37, for ease of understanding, the battery BT is not shown.

The operation switch SW7 is arranged in the area RG2 in the top view. This arrangement allows a user to easily access and operate the operation switch SW7 while holding the grip part 54. The operation switch SW7 is arranged in an intermediate position between the base parts 51, 52 within the area RG2. This arrangement allows a user to easily operate the operation switch SW7 regardless of the user's dominant hand (whether the user is right-handed or left-handed).

In FIG. 36, an axis HX is further shown. The axis HX is parallel to the front-rear direction and passes through the base parts 51, 52 and the grip part 54 of the handle 50g, in a view from the left-right direction of the lighting device. In this embodiment, the operation switch SW7 is arranged in a position through which the axis HX passes. In other words, the operation switch SW7 is configured to be arranged at substantially the same height as the handle 50g. More specifically, the operation switch SW7 is configured to be arranged within both of the axis HX shown in FIG. 36 and the area RG2 shown in FIG. 37. Thus, the operation switch SW7 is arranged in an area surrounded by the second base 20, the base parts 51, 52 and the grip part 54 in the top view and the side view. This arrangement allows a user to easily operate the operation switch SW7 while holding the grip part 54. In this embodiment, the operation switch SW7 is arranged at substantially the same height as the grip part 54 of the handle 50g. Further, the operation switch SW7 is arranged in an area RG3 in which the axis HX and the axis SX cross each other. Thus, the operation switch SW7 can be easily operated while the lighting device 100g is stably held.

### G5. The Structure of the Fixing Part 30g

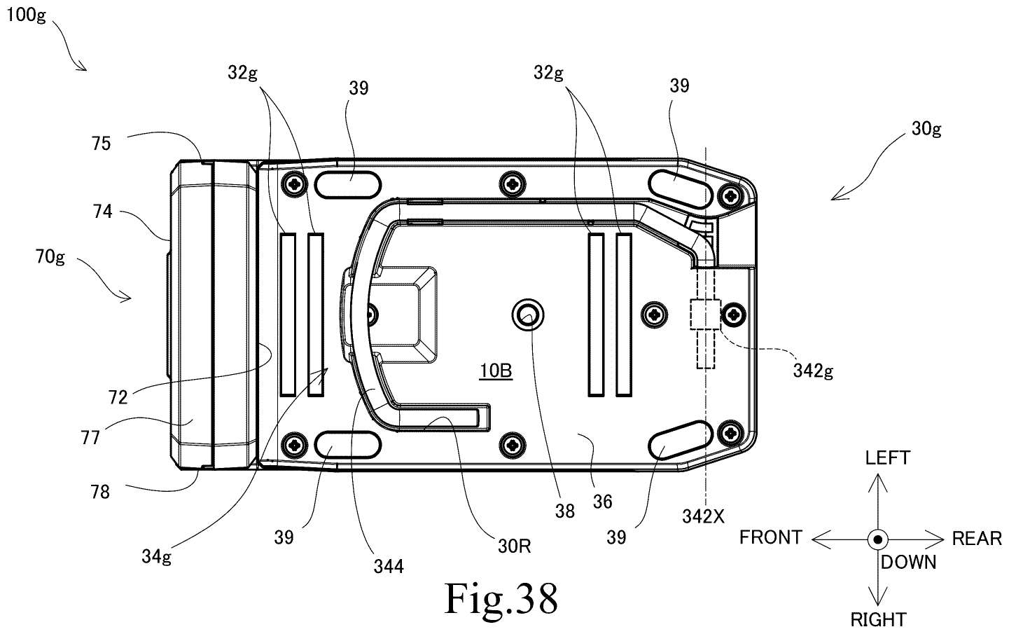

As shown in FIG. 38, the fixing part 30g includes magnets 32g, a hook 34g, a base body 36, a female thread 38 and supports 39. The base body 36 and the female thread 38 have the same structure as those of the first embodiment and are therefore not described here.

The magnets 32g are different in shape and arrangement position from the magnets 32 of the first embodiment. Each of the magnets 32g is elongate in the left-right direction, and is arranged in front of a movable part 342g of a hook 34g.

The hook 34g is different from the hook 34 of the first embodiment in that the hook 34g has the movable part 342g in place of the movable part 342. The movable part 342g is a member having a cylindrical shape extending in the left-right direction. The movable part 342g connects the body part 344 and the base body 36 such that the body part 344 can rotate around a rotational axis 342X parallel to the left-right direction.

The supports 39 are formed of an elastic material such as rubber. The supports 39 are arranged at four corners of the base body 36. The supports 39 serve as slip stoppers and cushioning materials when the fixing part 30g is placed on an installation object.

### G6. The Structure of the Cover 80

### G6-1. The Configuration of the Cover 80

As shown in FIG. 30, the lighting device 100g is configured such that the cover 80 can be attached thereto. In this embodiment, the cover 80 can be removably attached to more than one position of the lighting device 100g.

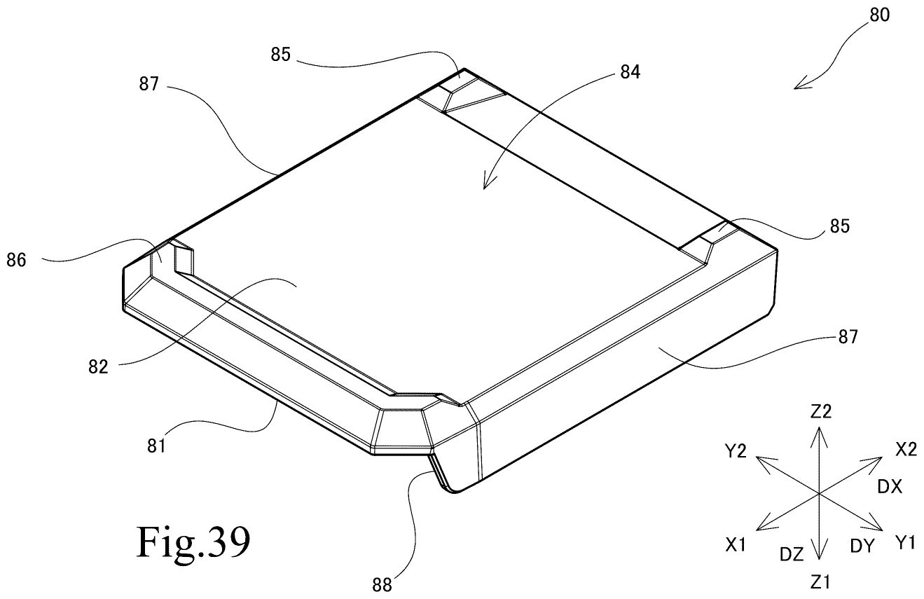

As shown in FIGS. 39 to 41, the cover 80 is formed of synthetic resin such as ABS resin. The cover 80 has a function of protecting the lighting device 100g and a function as a magnetic shield for shielding a magnetic field of the magnets 32g, by covering at least part of the lighting device 100g. The cover 80 may be formed of a ferromagnetic material such as iron in order to improve the function as a magnetic shield, or it may be formed of elastomer such as rubber in order to improve the impact resistance.

In the following description, as for the direction of the cover 80, where the cover 80 is attached to the first base 10g of the lighting device 100g as shown in FIG. 30, a direction corresponding to the front-rear direction of the lighting device 100g is defined as a first direction DX. In the first direction DX, a direction corresponding to the front direction is defined as a first side X1 of the first direction and a direction corresponding to the rear direction is defined as a second side X2 of the first direction. A direction corresponding to the left-right direction of the lighting device 100g is defined as a second direction DY. In the second direction DY, a direction corresponding to the right direction is defined as a first side Y1 of the second direction and a direction corresponding to the left direction is defined as a second side Y2 of the second direction. A direction corresponding to the up-down direction of the lighting device 100g is defined as a third direction DZ. In the third direction DZ, a direction corresponding to the upper direction is defined as a first side Z1 of the third direction and a direction corresponding to the lower direction is defined as a second side Z2 of the third direction.

As shown in FIGS. 39 to 41, the cover 80 has a base 84 and two third locking parts 83. The base 84 has a flat plate-like shape and has a first surface 81 on the first side Z1 of the third direction and a second surface 82 on the second side Z2 of the third direction.

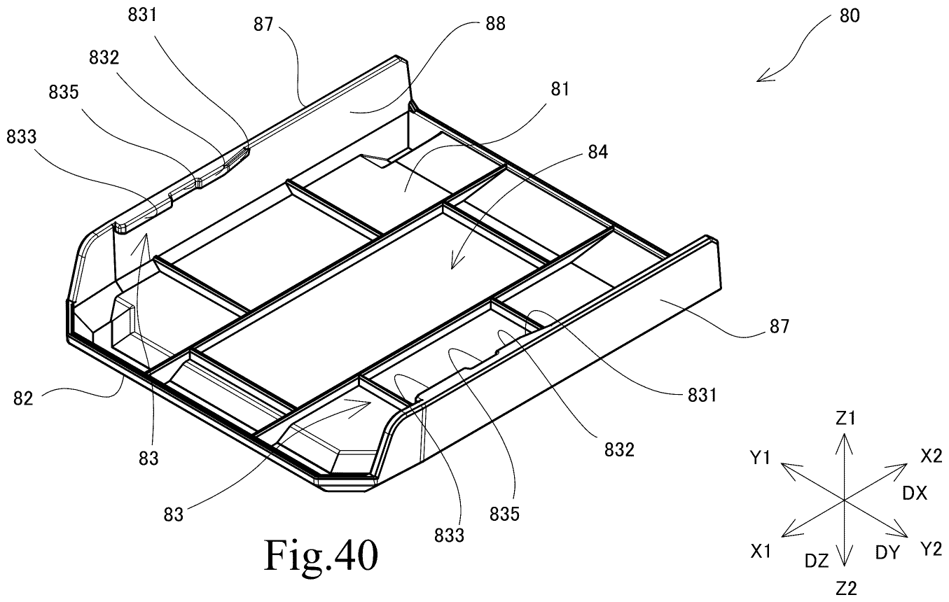

The first surface 81 faces at least part of the lighting device 100g with the cover 80 attached to the lighting device 100g. As shown in FIG. 40, a pair of side walls 87 are respectively connected to both ends of the first surface 81 in the second direction DY. The side walls 87 face each other in the second direction DY. The third locking parts 83 are formed in so-called mirror symmetry and have substantially the same structure. The side walls 87 and the second surface 82 of the base 84 define a recessed part 88 that is configured to receive part of the lighting device 100g such as the first base 10g and the lighting part 70g.

The side walls 87 protrude from the base 84 to the first side Z1 of the third direction and extend linearly in the first direction DX. The third locking parts 83 are respectively formed on ends of the side walls 87 on the first side Z1 of the third direction.

The third locking parts 83 protrude inward of the cover 80 from the respective side walls 87 and are configured to be engaged with the first locking parts 91 of the first base 10g or the second locking part 92 of the lighting part 70g when the first base 10g or the lighting part 70g is received by the recessed part 88. As shown in FIG. 40, each of the third locking parts 83 has an inclined part 831, a first projection 832, a recess 835 and a second projection 833, which are formed in this order from the second side X2 to the first side X1 of the first direction.

The first projection 832 and the second projection 833 are configured to be engaged with the first and second grooves 912, 916 of the first locking part 91. The first projection 832 and the second projection 833 are further configured to be engaged with the first and second grooves 922, 926 of the second locking part 92.

### G6-2. How to Attach the Cover 80

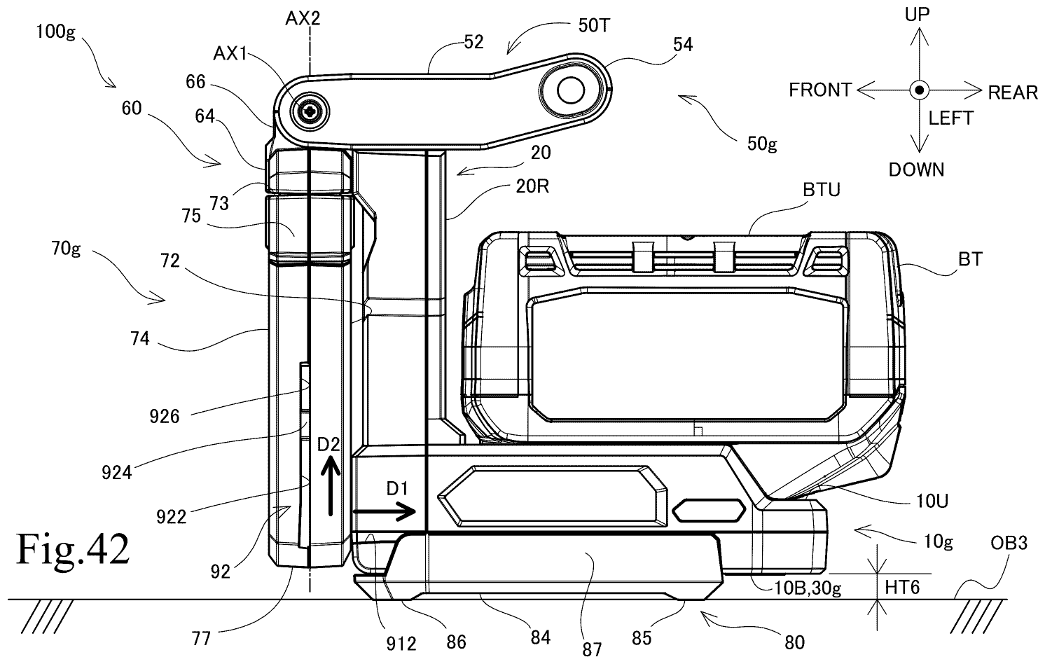

In order to attach the cover 80 to the first base 10g, an end of the recessed part 88 of the cover 80 on the second side X2 of the first direction is engaged with the front end 10F of the first base 10g, and the cover 80 is moved in a direction D1 shown in FIGS. 35 and 42 to the rear side of the first base 10g. Specifically, the inclined part 831 and the first projection 832 of the third locking part 83 are first engaged with the first groove 912 of the first locking part 91.

In this embodiment, the lighting part 70g does not have a groove that can be engaged with the first locking part 91. Therefore, if the lighting part 70g is placed in front of the first groove 912 after the cover 80 is attached to the first base 10g, the presence of the lighting part 70g avoids or prevents the cover 80 from dropping off forward from the locking part 91. In this embodiment, the cover 80 is attached to the first base 10g after the lighting part 70g is moved away from the front of the first groove 912. A groove that can be engaged with the first groove 912 may however be formed in the left and right side surfaces 75, 78 of the lighting part 70g. With such a structure, the cover 80 can be attached to the first base 10g while the lighting part 70g is left placed in front of the first groove 912.

When the cover 80 is slid to the rear side of the first base 10g, the inclined part 831 and the first projection 832 are guided to the rear side of the first base 10g in the direction D1 by the first groove 912. When the cover 80 is further slid to the rear side of the first base 10g, the inclined part 831 abuts on the trapezoidal part 914, and the side wall 87 is elastically deformed following the shape of the inclined part of the trapezoidal part 914 in a direction away from the first base 10g. When the cover 80 is further slid until the recess 835 reaches the trapezoidal part 914, the side wall 87 is restored from the elastically deformed state, and the recess 835 is fitted on the trapezoidal part 914. As a result, as shown in FIG. 42, the third locking part 83 is engaged with the first locking part 91, and the cover 80 is attached to the first base 10g.

In this embodiment, the recessed part 88 extends through the cover 80 in the first direction DX. The second groove 916 extends to the vicinity of a rear end of the first base 10g. More specifically, the second groove 916 is configured to receive the inclined part 831, the first projection 832, the recess 835 and the second projection 833 of the third locking part 83. Therefore, in this embodiment, the cover 80 can be attached to the first base 10g in a reverse direction to the above-described direction of the cover 80 in the first direction DX.→Specifically, an end of the recessed part 88 of the cover 80 on the first side X1 of the first direction is engaged with the front end 10F of the first base 10g, and the cover 80 is moved to the rear side of the first base 10g. The cover 80 can be attached to the first base 10g by engaging the third locking part 83 only with the second groove 916. The second groove 916 may however be formed long enough to receive only the inclined part 831 and the first projection 832.

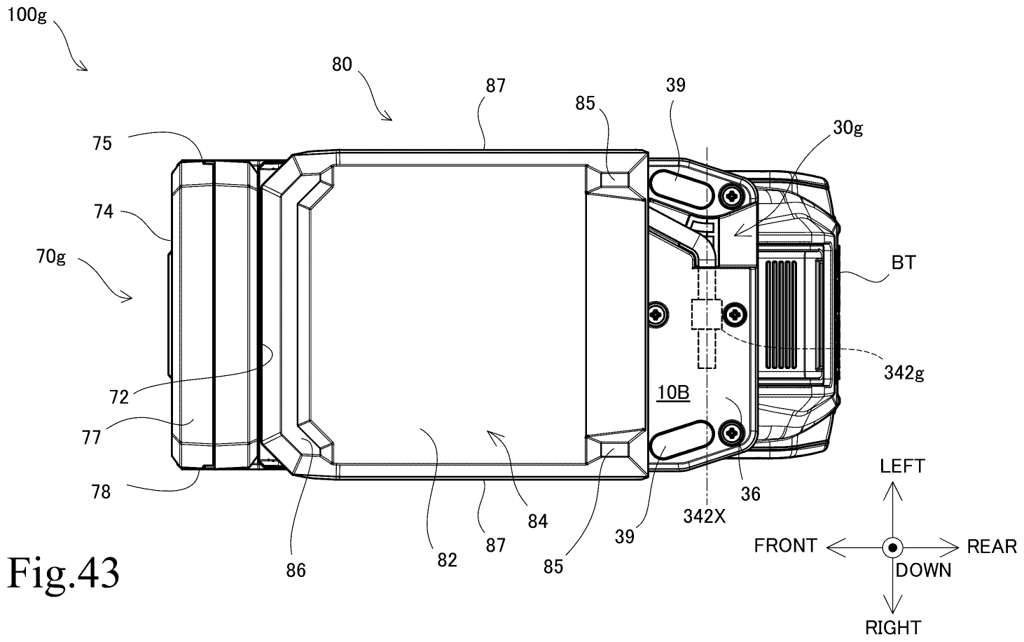

As shown in FIG. 43, the lower surface 10B of the first base 10g and most of the fixing part 30g are covered by the base 84 of the cover 80 when the cover 80 is attached to the first base 10g. In this embodiment, the base 84 is configured to cover all of the magnets 32g of the fixing part 30g. The base 84 serves as a magnetic shield for shielding the magnetism of the magnets 32g while the cover 80 is attached to the first base 10g. With this structure, for example, unwanted metal dust is avoided or prevented from being attracted to the magnets 32g when the lighting device 100g is stored for a long period of time. Further, a user can use the lighting device 100g without choosing to utilize the magnets 32g.

As shown in FIG. 43, the movable part 342g of the hook 34g is configured not to be covered by the first base 10g even when the cover 80 is attached to the first base 10g. In other words, the cover 80 is configured not to interfere with the movable part 342g of the hook 34g when the cover 80 is attached to or removed from the first base 10g. With this structure, the cover 80 can be attached to or removed from the first base 10g even while the hook 34g is taken out of the recessed part 30R to be used. Further, if the hook 34g is taken out of the recessed part 30R, the hook 34g can be rotated around the movable part 342g while the cover 80 is left attached to the first base 10g.

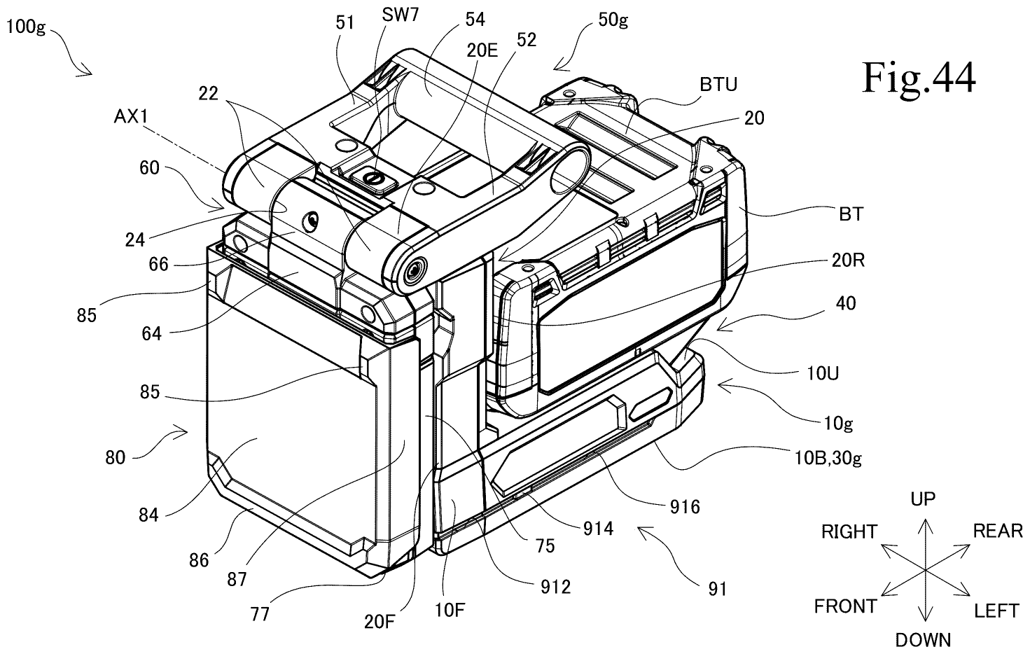

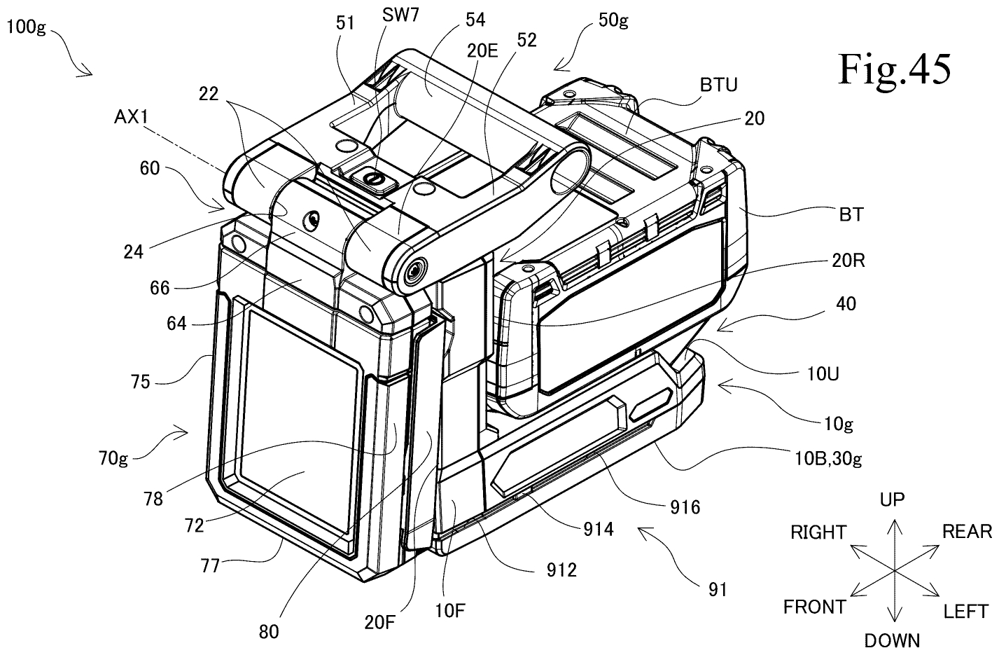

In order to attach the cover 80 to the lighting part 70g, the end of the recessed part 88 of the cover 80 on the second side X2 of the first direction is engaged with the upper side surface 77 of the lighting part 70g, and the cover 80 is moved in a direction D2 shown in FIG. 35 toward the lower side surface 73 of the lighting part 70g. Specifically, the inclined part 831 and the first projection 832 of the third locking part 83 are first engaged with the first groove 922 of the second locking part 92. As shown in FIGS. 44 and 45, in this embodiment, the cover 80 can be attached only to a position (hereinafter also referred to as a “first cover position”) where the base 84 faces the rear surface 74 of the lighting part 70g. The cover 80 may however be configured to be attached not only to the first cover position but also to a position (hereinafter also referred to as a “second cover position”) where the base 84 faces the light emitting surface 72 of the lighting part 70g.

As shown in FIG. 42, when the cover 80 is slid toward the lower side surface 73 of the lighting part 70g, the inclined part 831 and the first projection 832 are guided toward the lower surface 73 in the direction D2 via the first groove 922. When the cover 80 is further slid toward the lower surface 73, the inclined part 831 abuts on the trapezoidal part 924, and the side wall 87 is elastically deformed along the shape of the inclined part of the trapezoidal part 924 in a direction away from the lighting part 70g. When the cover 80 is further slid until the recess 835 reaches the trapezoidal part 924, the side wall 87 is restored from the elastically deformed state, and the recess 835 is fitted on the trapezoidal part 924. As a result, as shown in FIG. 44, the third locking part 83 is engaged with the second locking part 92, and the cover 80 is attached to the lighting part 70g. As shown in FIGS. 44 and 45, the position of the lighting part 70g can be changed between the first position and the second position while the cover 80 is left mounted thereto.

When, for example, the cover 80 is not attached to the first base 10g in order to utilize the magnets 32g, the cover 80 is separated from the first base 10g if the cover 80 cannot be attached to a position other than the first base 10g. Thus, the risk of loss of the cover 80 is increased. In the lighting device 100g of this embodiment, however, the cover 80 can be attached to a position other than the first base 10g. Therefore, when the cover 80 is not attached to the first base 10g, the cover 80 can be attached to the position other than the first base 10g so that loss of the cover 80 is avoided or prevented. In this embodiment, the cover 80 can be attached only to the lighting part 70g, besides the first base 10g. The cover 80 may however be configured to be attached to the second base 20, instead of or in addition to the lighting part 70g, besides the first base 10g.

### G6-3. The Structure of Support Projections 85, 86

As shown in FIG. 39, in this embodiment, support projections 85, 86 are formed on the second surface 82 of the cover 80. Specifically, two support projections 85 are formed on both ends in the second direction DY of an end part of the base 84 on the second side X2 of the first direction. One support projection 86 is formed extending in the second direction DY on an end part of the base 84 on the first side X1 of the first direction. By provision of the support projections 85, 86, the lighting device 100g with the cover 80 attached thereto can be supported at three points and thus stably held in use. The cover 80 may have two support projections 86, in place of the single support projection 86, which are formed similarly to the support projections 85 on both ends in the second direction DY of an end part of the base 84 on the first side X1 of the first direction.

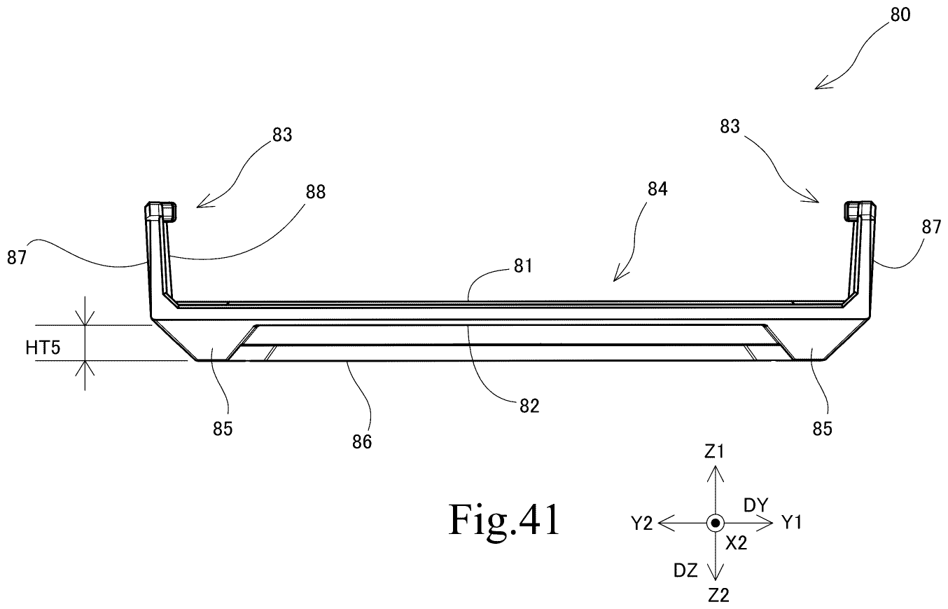

As shown in FIG. 41, the support projections 85, 86 protrude by a height HT5 in a direction away from the base 84, or a direction away from the lighting device 100g with the cover 80 attached to the lighting device 100g. As shown in FIG. 42, when the lighting device 100g with the cover 80 attached to the first base 10g is placed on an installation object OB3, the lower surface 10B of the first base 10g, or the fixing part 30g is separated from the installation object OB3 by a distance HT6. The distance HT6 is a sum of the thickness of the base 84 in the third direction DZ and the height HT5 of the support projections 85, 86. By provision of the support projections 85, 86, the distance from the magnets 32g to the installation object OB3 is increased, so that the magnets 32g are avoided or prevented from being attracted to the installation object OB3 or foreign matters on the installation object OB3. Thus, the magnetic shielding effectiveness of the cover 80 is improved.

As described above, the lighting device 100g of this embodiment further has the operation switch SW7 that is configured to be manually depressed downward by a user to be turned on and off. The axis SX that is parallel to the depressing direction PD of the operation switch SW7 and passes through the operation switch SW7 is arranged to pass through the first base 10g. In other words, the operation switch SW7 is configured to be depressed in a direction toward the first base 10g. According to this embodiment, the operation switch SW7 can be depressed in the direction toward the fixing part 30g and the first base 10g that is exclusively placed on an installation object, so that the lighting device 100g can be held stably while the operation switch SW7 is operated.

According to this embodiment, the handle 50g includes the pair of base parts 51, 52 that extend rearward from the upper end part 20E of the second base 20, and the grip part 54 that is connected between the base parts 51, 52 and configured to be held by a user. The operation switch SW7 is arranged in the area RG2 surrounded by the second base 20, the base parts 51, 52 and the grip part 54. This arrangement allows a user to easily access and operate the operation switch SW7 while holding the grip part 54.

According to this embodiment, the grip part 54 is arranged in the area AR6 below the uppermost end TP of the rotatable range AR5 that the lighting part 70g occupies when rotated around the first rotational axis AX1. This arrangement of the grip part 54 below the uppermost end TP of the rotatable range AR5 of the lighting part 70g avoids or prevents increase in size of the lighting device 100g in the up-down direction.

According to this embodiment, the grip part 54 is arranged below the uppermost end TP and just above the first base 10g. By this arrangement, when the fixing part 30g of the lighting device 100g is placed on an installation object, a user can easily generate torque around the first base 10g and the fixing part 30g, and can separate the fixing part 30g from the installation object by applying a relatively small force to the grip part 54. Further, the handle 50g can be utilized to protect the battery BT mounted on the first base 10g.

According to this embodiment, the cover 80 is configured to be removably attached to the first base 10g. The cover 80 is configured to cover at least the lower side of the fixing part 30g when attached to the first base 10g. Therefore, by attaching the cover 80, the lighting device 100g can be used while stopping or suppressing the function of fixing the lighting device 100g to an installation object or an installation accessory via the fixing part 30.

According to this embodiment, the cover 80 has the first surface 81 that faces the lighting device 100g with the cover 80 attached to the lighting device 100g, and the second surface 82 on the opposite side to the first surface 81. The second surface 82 has the support projections 85, 86 protruding in a direction away from the lighting device 100g with the cover 80 attached to the lighting device 100g. By provision of the support projections 85, 86, the lighting device 100g can be supported at three points via the cover 80 and thus stably held in use. Further, by provision of the support projections 85, 86, the distance from the magnets 32g to the installation object OB3 is increased, so that the magnets 32g are avoided or prevented from being attracted to the installation object OB3 or foreign matters on the installation object OB3. Thus, the magnetic shielding effectiveness of the cover 80 is improved.

According to this embodiment, the cover 80 is configured to be attached to two positions including the first base 10g and the lighting part 70g. When the cover 80 is not attached to the first base 10g, the cover 80 can be attached to the lighting part 70g so that loss of the cover 80 is avoided or prevented.

### H. OTHER EMBODIMENTS

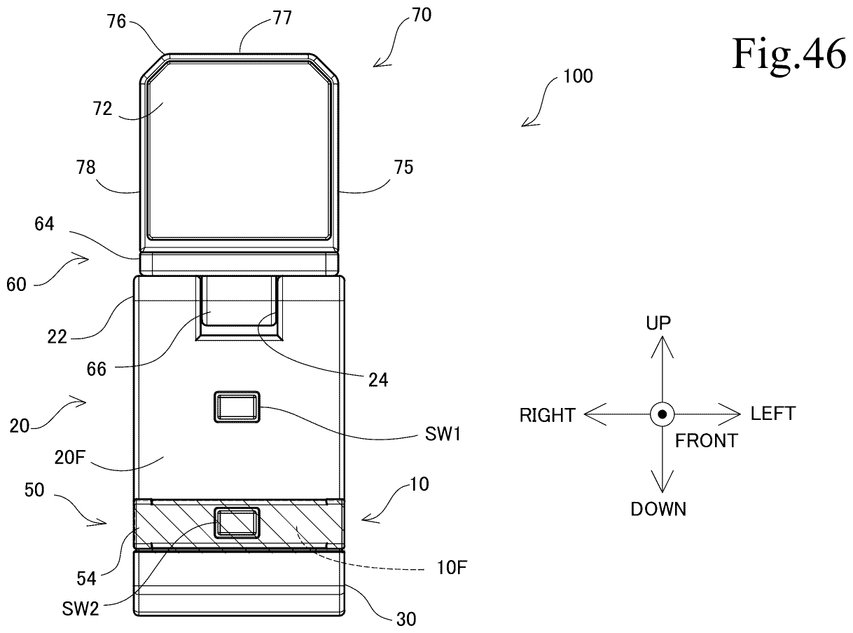

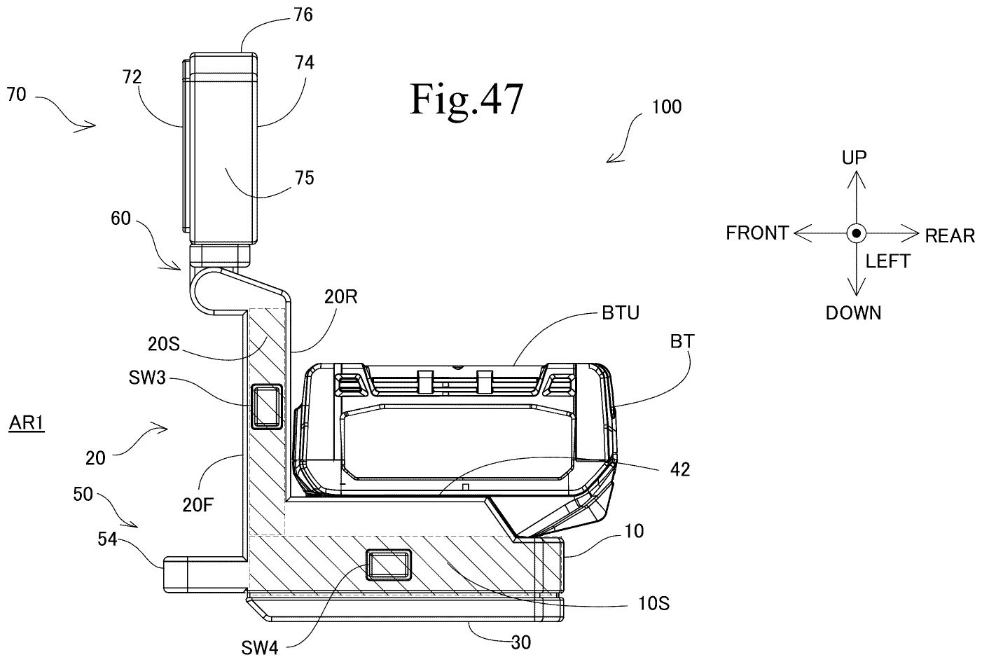

(H1) In the above-described the first embodiment, the power switch button SW is arranged on the left side surface 75 of the housing 76, but it may be arranged on the other parts of the housing 76, such as the upper side surface 77, the rear surface 74 and the right side surface 78. Further, as shown in FIGS. 46 and 47, the power switch button SW may be arranged on members other than the lighting part 70, such as the first base 10 and the second base 20.

As shown in FIG. 46, a power switch button SW1 may be arranged on the side opposite to the battery BT mounted to the battery mounting part 40, or, for example, on the front surface 20F of the second base 20. Further, a power switch button SW2 may be arranged between the grip part 54 and the first base 10, or, for example, on the front end 10F of the first base 10. In FIG. 46, for ease of technical understanding, an area of the front end 10F of the first base 10 is shown by hatching. With the arrangement of the power switch button SW2 between the grip part 54 and the first base 10, a user can easily operate the power switch button SW2 while holding the grip part 54. Further, the power switch button SW2 is surrounded by the handle 50, so that the power switch button SW2 is protected by the handle 50. The power switch button SW2 may be arranged between the grip part 54 and the second base 20.

As shown in FIG. 47, the power switch button SW may be arranged on any of the side surfaces of the first base 10, the side surfaces of the second base 20 and the side surfaces of the housing 76 of the lighting part 70. The “side surfaces of the first base 10” mean surfaces that connect the upper surface 10U and the lower surface 10B of the first base 10. The “side surfaces of the second base 20” mean surfaces that connect the front surface 20F and the rear surface 20R of the second base 20. In the lighting device 100 having such a structure, the power switch button SW can be efficiently arranged by utilizing a part having a smaller area such as the side surfaces than the other parts.

As shown in FIG. 47, a power switch button SW3 may be arranged on a left-right side surface 20S of the second base 20. The “left-right side surface 20S” means a surface that connects the front surface 20F and the rear surface 20R of the second base 20 and crosses the left-right direction. Specifically, the left-right side surface 20S includes a right side surface and a left side surface of the second base 20. In the lighting device 100 having such a structure, the power switch button SW3 is arranged on the left or right side surface 20S of the second base 20 that is easy to access for a user, so that the user can easily operate the power switch button SW3 with one hand while holding the housing 76 of the lighting part 70 with the other hand. Therefore, the lighting device 100 is provided that facilitates two operations of adjusting the direction of light irradiation by the lighting part 70 and turning on and off the lighting part 70, and is highly convenient.

As shown in FIG. 47, a power switch button SW4 may be arranged on a left-right side surface 10S of the first base 10. The “left-right side surface 10S” means a surface that connects the upper surface 10U and the lower surface 10B of the first base 10 and crosses the left-right direction. Specifically, the left-right side surface 10S includes a right side surface and a left side surface of the first base 10. The power switch button SW4 is arranged at a position apart from the lighting part 70, so that the power switch button SW4 is avoided or prevented from being accidentally operated during rotating operation of the lighting part 70. In FIG. 47, for ease of technical understanding, (the left side surfaces of) the left-right side surfaces 10S and 20S are shown by hatching.

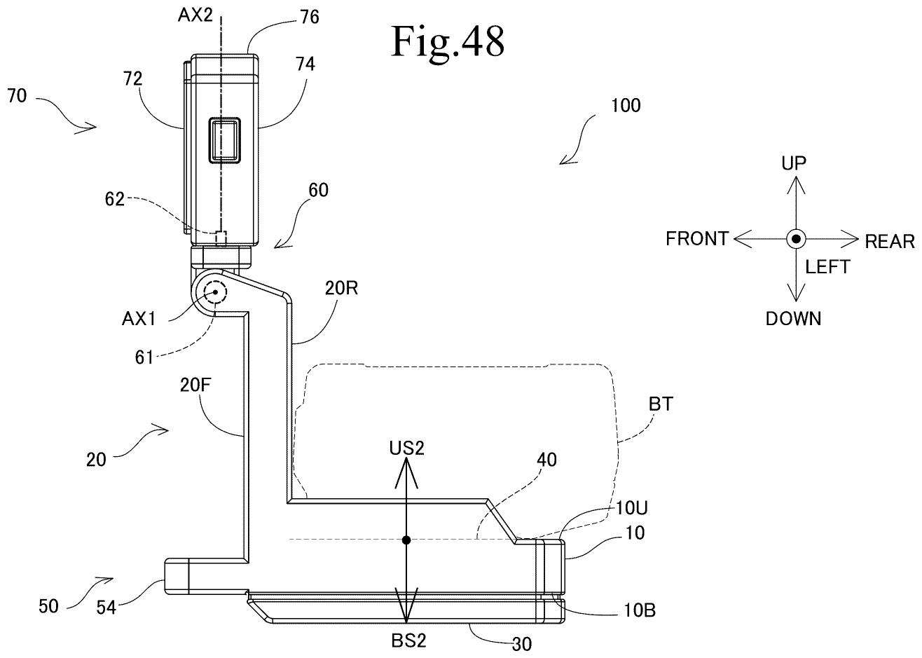

(H2) In the above-described embodiments, the up-down direction is defined where the side on which the fixing part 30 is located relative to the first base 10 is defined as the lower side BS, and the side opposite to the lower side BS relative to the first base 10 is defined as the upper side US. As shown in FIG. 48, however, the up-down direction may be defined where the side on which the battery BT mounted to the battery mounting part 40 is located relative to the first base 10 is defined as an upper side US2, and the side opposite to the upper side US2 relative to the first base 10 is defined as a lower side BS2.

The present disclosure is not limited to any of the above-described embodiments but may be implemented by a diversity of configurations without departing from the scope of the disclosure. For example, the technical features of any of the above embodiments may be replaced or combined appropriately, in order to solve part or all of the problems described above or in order to achieve part or all of the advantageous effects described above. Any of the technical features may be omitted appropriately unless the technical feature is described as essential in the description hereof.

Further, in view of the nature of the present disclosure, the above-described embodiments and their modifications, the following aspects are provided. At least one of the following aspects can be adopted alone or in combination with at least one of the features of the lighting devices 100, 100b, 100c, 100d, 100e, 100f, 100 g of the above-described embodiments, their modifications and the claimed invention.

(Aspect 1) The grip part has a rod-like member protruding rearward of the third rotational axis.

The stick 57 is an example of the “rod-like member”.

(Aspect 2) A bent part is provided on an upper end of the second base and bent frontward of the second base, and
the connecting part between the lighting part and the second base comprises the bent part.

The bent part 22 is an example of the “bent part”.

(Aspect 3) A projection is formed on the rear side of the second base.

The projection 26 is an example of the “projection”.

(Aspect 4) The grip part is further arranged at a predetermined height from a lower end of the first base.

(Aspect 5) The lighting part has a cuboid shape, and
the operation member is arranged on a side surface of the lighting part.

(Aspect 6) The grip part is connected to the first or second base so as to be rotated around a third rotational axis crossing the extending direction of the second base, and can be changed in position between a front grip position located in front of the second base and a rear grip position located behind the first base by rotating around the third rotational axis.

According to this aspect, the lighting device is provided that allows freely changing the position of the grip part and is highly convenient.

(Aspect 7) In the lighting device as defined in aspect 6, the grip part is arranged in a position to be prevented from interfering with the lighting part that is rotated around the first rotational axis.

In the lighting device according to this aspect, the rotation range of the lighting part is avoided from being reduced due to the existence of the grip part, while the grip part is arranged on the front side of the lighting device.

(Aspect 8) The fixing part includes a female thread configured to be fitted to an installation accessory having a male thread.

(Aspect 9) The operation member is arranged on a side surface of the first base, a side surface of the second base, or a side surface of the lighting part.

(Aspect 10) In the lighting device as defined in aspect 9, the operation member is arranged on a right or left side surface of the second base.

(Aspect 11) The grip part is arranged between a lower end of the first base and a connecting part between the lighting part and the second base in the up-down direction, in a rear area behind the second base, in a view from the left-right direction of the lighting device.

### DESCRIPTION OF THE REFERENCE NUMERALS

10: first base, 10B: lower surface, 10F: front end, 10S: left-right side surface. 10U: upper surface, 12: restriction part, 14: restriction part, 20, 20c, 20e: second base, 20E: upper end part, 20F: front surface, 20R: rear surface, 20S: left-right side surface, 20U: upper surface, 22: bent part, 23: switch, 24: recess, 26: projection, 28: controller, 29: magnetic sensor, 30, 30g: fixing part, 30R: recessed part, 32, 32g: magnet, 34, 34g: hook, 36: base body, 38: female thread, 40, 40c: battery mounting part, 42: side wall, 43: guide groove, 46: terminal, 48: connector, 50, 50b, 50d, 50f, 50g: handle, 51: base part, 52: base part, 54, 54f: grip part, 55: storing part, 56: connecting part, 57: stick, 57E: tip end, 58: shaft part, 60: connecting member, 61: first fitting part, 62: second fitting part, 64: base part, 66: protruding part, 70, 70g: lighting part, 72: light emitting surface, 73: lower side surface, 74: rear surface, 75: left side surface, 76: housing, 77: upper side surface, 78: right side surface, 79: magnet, 80: cover, 81: first surface, 82: second surface, 83: third locking part, 84: base, 85: support projection, 86: support projection, 87: side wall, 88: recessed part, 91: first locking part, 92: second locking part, 100, 100R, 100b, 100c, 100d, 100e, 100f, 100g: lighting device, 200A: tripod, 200B: clamp, 202: male thread, 203: body, 204: male thread, 205: support part, 207: adjustment part, 342: movable part, 344: body part, 831: inclined part, 832: first projection, 833: second projection, 835: recess, 912: first groove, 914: trapezoidal part, 916: second groove, 922: first groove, 924: trapezoidal part, 926: second groove, AX1: first rotational axis, AX2: second rotational axis, AX3: third rotational axis, BT: battery, BTU: upper end, CG: center of gravity, CP: center, DB, DB2: mounting/removing direction, ED1: first extending direction, ED2: second extending direction, ED3: third extending direction, FP: front grip position, GC: center of gravity OB, OB2, OB3: installation object, PG: center of gravity, RP: rear grip position, SH: area, SW, SW1, SW2, SW3, SW4: power switch button, SW7: operation switch, UP: lower grip position

1. A lighting device, comprising:
a first base having a fixing part that is configured to be fixed to an installation object or an installation accessory;
a second base extending from the first base;
a battery mounting part that is arranged on the first or second base and has a terminal configured to be electrically connected to a battery, and a connector configured to be mechanically connected to the battery, the battery mounting part being configured such that the battery can be removably mounted thereto; and
a lighting part that is configured to emit light by power supplied from the battery and is connected to the second base so as to be rotated around a first rotational axis crossing an extending direction of the second base;
wherein:
when an up-down direction is defined where a side of the first base on which the fixing part is located is defined as a lower side and a side of the first base on which the second base is located is defined as an upper side, the extending direction of the second base is a direction upward from the first base,
the battery mounting part is configured such that the battery mounted to the battery mounting part is arranged on the upper side of the first base;
and
a connecting part between the lighting part and the second base is arranged above the battery mounted to the battery mounting part in the up-down direction.

2. A lighting device, comprising:
a first base having a fixing part that is configured to be fixed to an installation object or an installation accessory;
a second base extending from the first base;
a battery mounting part that has a terminal configured to be electrically connected to a battery, and a connector configured to be mechanically connected to the battery, the battery mounting part being configured such that the battery can be removably mounted thereto; and
a lighting part that is configured to emit light by power supplied from the battery;
wherein:
when an up-down direction is defined where a side of the first base on which the fixing part is located is defined as a lower side and a side of the first base on which the second base is located is defined as an upper side, an extending direction of the second base is a direction upward from the first base,
the lighting part is connected to an upper end of the second base so as to be rotated around a first rotational axis crossing the extending direction of the second base;
and
the battery mounting part is arranged in an area between the fixing part and a connecting part between the lighting part and the second base in the up-down direction.

3. The lighting device as defined in claim 1, wherein the battery mounting part is arranged on the first base.

4. A lighting device, comprising:
a first base;
a battery mounting part that is arranged on the first base and has a terminal configured to be electrically connected to a battery, and a connector configured to be mechanically connected to the battery, the battery mounting part being configured such that the battery can be removably mounted thereto;
a second base extending from an upper side of the first base in an extending direction upward from the first base, when an up-down direction is defined where a side on which the battery mounted to the battery mounting part is located relative to the first base is defined as the upper side and a side opposite to the upper side relative to the first base is defined as a lower side;
and
a lighting part that is configured to emit light by power supplied from the battery and is connected to the second base so as to be rotated around a first rotational axis crossing the extending direction;
wherein:
a connecting part between the lighting part and the second base is arranged above the battery mounted to the battery mounting part in the up-down direction.

5. The lighting device as defined in claim 4, further comprising a fixing part that is arranged on the lower side of the first base and configured to be fixed to an installation object or an installation accessory.

6. The lighting device as defined in claim 1, wherein the battery mounting part is arranged on a side opposite to the fixing part relative to the first base.

7. The lighting device as defined in claim 1, wherein the first base extends in a direction orthogonal to the extending direction of the second base.

8. The lighting device as defined in claim 1, wherein the fixing part includes a magnet configured to magnetically fix the first base to an installation object.

9. The lighting device as defined in claim 1, wherein the fixing part includes a hook configured to be hooked to an installation object.

10. The lighting device as defined in claim 1, wherein the lighting part is further configured to be rotated around a second rotational axis orthogonal to the first rotational axis.

11. The lighting device as defined in claim 1, wherein the lighting part has a light emitting surface that is configured to emit the light, and is configured such that the position of the light emitting surface is changeable between a first position in which at least part of the light emitting surface is covered by the second base and a second position in which the whole of the light emitting surface is exposed to the outside of the lighting device.

12. The lighting device as defined in claim 1, wherein:
when a front-rear direction is defined where a direction toward the second base from a center of the first base is defined as a front direction, and the opposite direction is defined as a rear direction, and a direction orthogonal to the front-rear direction and the up-down direction is defined as a left-right direction, in a top view of the first base,
a width in a longitudinal direction of the lighting part is shorter than a width in an extending direction of the first base in a view from the left-right direction of the lighting device.

13. The lighting device as defined in claim 1, further comprising:
an operation member that is configured to be manually operated in one direction by a user to turn on and off the lighting part,
wherein:
an axis that is parallel to a depressing direction of the operation member and passes through the operation member is arranged to pass through the first base.

14. The lighting device as defined in claim 13, further comprising:
a handle including: (i) a pair of base parts that extend rearward from the second base, and (ii) a grip part that is connected between the base parts and configured to be held by a user, when a front-rear direction is defined where a direction toward the second base from a center of the first base is defined as a front direction and the opposite direction is defined as a rear direction in a top view of the first base,
wherein:
the operation member is arranged in an area surrounded by the second base, the base parts and the grip part.

15. The lighting device as defined in claim 1, further comprising:
a handle including: (i) a pair of base parts that extend rearward from the second base, and (ii) a grip part that is connected between the base parts and configured to be held by a user, when a front-rear direction is defined where a direction toward the second base from a center of the first base is defined as a front direction and the opposite direction is defined as a rear direction in a top view of the first base,
wherein:
the grip part is arranged below an uppermost end of an area that the lighting part occupies when rotated around the first rotational axis.

16. The lighting device as defined in claim 15, wherein the grip part is arranged above the first base in a rear area behind the second base.

17. The lighting device as defined in claim 1, wherein the first base, the second base and the lighting part all have a cuboid shape.

18. The lighting device as defined in claim 1, comprising:
a cover that is configured to cover at least part of the lighting device when removably attached to at least one position of the lighting device, where the at least part of the lighting device includes a lower side of the fixing part.

19. The lighting device as defined in claim 18, wherein:
the cover has a first surface that faces the lighting device with the cover attached to the least one position of the lighting device, and a second surface on the opposite side to the first surface, and
the second surface has a support projection that protrudes in a direction away from the lighting device with the cover attached to the least one position of the lighting device.

20. The lighting device as defined in claim 18, wherein the cover is configured to be attached to two or more positions including: (i) the lower side of the first base and (ii) a position other than the lower side of the first base, on the first base, the second base or the lighting part.
